(19) United States
(12) Patent Application Publication
(10) Pub. No.: US 2026/0045192 A1
(43) Pub. Date: Feb. 12, 2026

(54) ELECTRONIC DEVICE, METHOD AND RECORDING MEDIUM FOR SUPPORTING BURN-IN COMPENSATION IN SECURE MODE

(71) Applicant: Samsung Electronics Co., Ltd., Suwon-si (KR)

(72) Inventors: Chankyu HAN, Suwon-si (KR); Jehyun KO, Suwon-si (KR); Jaewon SON, Suwon-si (KR); Seungwon KIM, Suwon-si (KR)

(21) Appl. No.: 19/303,864

(22) Filed: Aug. 19, 2025

Related U.S. Application Data
(63) Continuation of application No. PCT/KR2025/011388, filed on Jul. 30, 2025.

(30) Foreign Application Priority Data
Aug. 7, 2024 (KR) 10-2024-0105192
Oct. 24, 2024 (KR) 10-2024-0146456

(51) Int. Cl. G09G 3/20; G06F 21/84

(52) U.S. Cl. CPC G09G 3/20; G06F 21/84; G09G 2320/046; G09G 2340/12; G09G 2354/00; G09G 2358/00

(57) ABSTRACT

An electronic device and an operating method thereof are provided. The electronic device includes a display, memory, and a processor configured to generate a de-burn-in layer for a normal screen in a normal mode, identify a switch event to a secure mode in the normal mode in response to the switch event, switch from the normal mode to the secure mode in response to the switch event, acquire the de-burn-in layer in the secure mode, and display a secure screen to which the de-burn-in layer is applied through at least a portion of a display in the secure mode.

### CROSS-REFERENCE TO RELATED APPLICATION(S)

This application is a continuation application, claiming priority under 35 U.S.C. § 365(c), of an International application No. PCT/KR2025/011388, filed on Jul. 30, 2025, which is based on and claims the benefit of a Korean patent application number 10-2024-0105192, filed on Aug. 7, 2024, in the Korean Intellectual Property Office, and of a Korean patent application number 10-2024-0146456, filed on Oct. 24, 2024, in the Korean Intellectual Property Office, the disclosure of each of which is incorporated by reference herein in its entirety.

### TECHNICAL FIELD

The disclosure relates to an electronic device, an operating method thereof, and a recording medium for compensating for a burn-in phenomenon of a display.

### BACKGROUND ART

With the development of digital technology, various types of electronic devices, such as a smart phone, a tablet personal computer (PC), a laptop computer, a desktop computer, a digital camera, and/or a wearable device, are being widely used. Theses electronic devices are continuously being developed in terms of hardware and/or software to support and enhance their functions.

For example, a portable electronic device (hereinafter, ‘electronic device’) represented by a smart phone can now be equipped with various functions. The electronic device may include a touchscreen-based display to allow a user to easily access the various functions and may provide screens of various applications through the display.

The display (e.g., organic light emitting diode (OLED) display) of the electronic device may exhibit a residual image or burn-in phenomenon on a screen. The residual image on the display may occur due to hysteresis characteristics of a thin film transistor provided on pixels. Burn-in on the display may occur due to variation in the display's operating time (e.g., accumulated light emission time) for each of a plurality of pixels.

The above information is presented as background information only to with an understanding of the disclosure. No determination has been made, and no assertion is made, as to whether any of the above might be applicable as prior art with regard to the disclosure.

### DISCLOSURE OF INVENTION

### Technical Problem

Aspects of the disclosure are to address at least the above-mentioned problems and/or disadvantages and to provide at least the advantages described below. Accordingly, an aspect of the disclosure is to provide an electronic device, an operating method thereof, and a recording medium for compensating for a residual image or burn-in phenomenon on a display in the electronic device.

Another aspect of the disclosure is to provide an electronic device, an operating method thereof, and a recording medium for compensating for a residual image or burn-in phenomenon on a secure screen (or trusted user interface (TUI) screen) according to a secure mode (or secure world) of the electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a display configured to be capable of displaying a normal screen corresponding to a normal mode and a secure screen corresponding to a secure mode, memory, including one or more storage media, storing instructions, and the at least one processor, configured to be capable of operating in the normal mode and the secure mode, communicatively coupled to the display and the memory, wherein the instructions, when individually or collectively executed by the at least one processor, cause the electronic device to generate a de-burn-in layer for the normal screen in the normal mode, identify a switch event to the secure mode in the normal mode, switch from the normal mode to the secure mode in response to the switch event, acquire the de-burn-in layer in the secure mode, and display the secure screen to which the de-burn-in layer is applied through at least a portion of the display in the secure mode.

In accordance with another aspect of the disclosure, method of operating an electronic device is provided. The method includes generating a de-burn-in layer for a normal screen in a normal mode, identifying a switch event to a secure mode in the normal mode, switching from the normal mode to the secure mode in response to the switch event, acquiring the de-burn-in layer in the secure mode, and displaying a secure screen to which the de-burn-in layer is applied through at least a portion of a display in the secure mode.

To address the above-described subjects, various embodiments of the disclosure includes a computer-readable recording medium storing a program for executing the method in at least one processor.

In accordance with another aspect of the disclosure, one or more non-transitory computer-readable storage media storing one or more computer programs including computer-executable instructions that, when executed individually or collectively by at least one processor of an electronic device, cause the electronic device to perform operations are provided. The operations include generating a de-burn-in layer for a normal screen in a normal mode, identifying a switch event to a secure mode in the normal mode, switching from the normal mode to the secure mode in response to the switch event, acquiring the de-burn-in layer in the secure mode, and displaying a secure screen to which the de-burn-in layer is applied through at least a portion of a display in the secure mode.

The additional scope of applicability of the disclosure becomes clear from the following detailed description. However, various modifications and alterations within the spirit and scope of the disclosure is clearly understood by one of ordinary skill in the art and thus, detailed description and a specific embodiment of the disclosure, such as an embodiment of the disclosure should be understood as being provided as examples only.

According to an electronic device, an operating method thereof, and a recording medium, it is possible to support burn-in compensation (or de-burn-in) for a secure screen (or TUI screen) in a trusted execution environment (TEE). According to an embodiment of the disclosure, it is possible to match user experience (UX) look and feel (L&F) by supporting de-burn-in on the secure screen (or TUI screen). According to an embodiment of the disclosure, by supporting a de-burn-in layer generated in a rich execution environment (REE) to be available in a TEE, it is possible to unify UX L&F from a normal screen of a normal mode (or normal world) to a secure screen (or TUI screen) of a secure mode (or secure world). According to an embodiment of the disclosure, it is possible to provide new UX for burn-in compensation on the secure screen.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 schematically illustrates a configuration of an electronic device according to an embodiment of the disclosure;

FIG. 3 illustrates a display according to an embodiment of the disclosure;

FIG. 4 is a diagram illustrating providing of a user interface in a secure execution environment of an electronic device according to an embodiment of the disclosure;

FIG. 5 illustrates a secure screen in an electronic device according to an embodiment of the disclosure;

FIG. 6 is a flowchart illustrating an operating method of an electronic device according to an embodiment of the disclosure;

FIG. 7 is a diagram illustrating an operation of supporting burn-in compensation on a secure screen in an electronic device according to an embodiment of the disclosure;

FIG. 8 illustrates an operation of supporting burn-in compensation on a secure screen in an electronic device according to an embodiment of the disclosure;

FIG. 9 illustrates an operation of utilizing a de-burn-in layer in an electronic device according to an embodiment of the disclosure;

FIG. 10 is a flowchart illustrating an operating method of an electronic device according to an embodiment of the disclosure;

FIG. 11 illustrates providing a trusted user interface (TUI) screen in an electronic device according to an embodiment of the disclosure; and

FIG. 12 illustrates providing a TUI screen in an electronic device according to an embodiment of the disclosure.

The same reference numerals are used to represent the same elements throughout the drawings.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

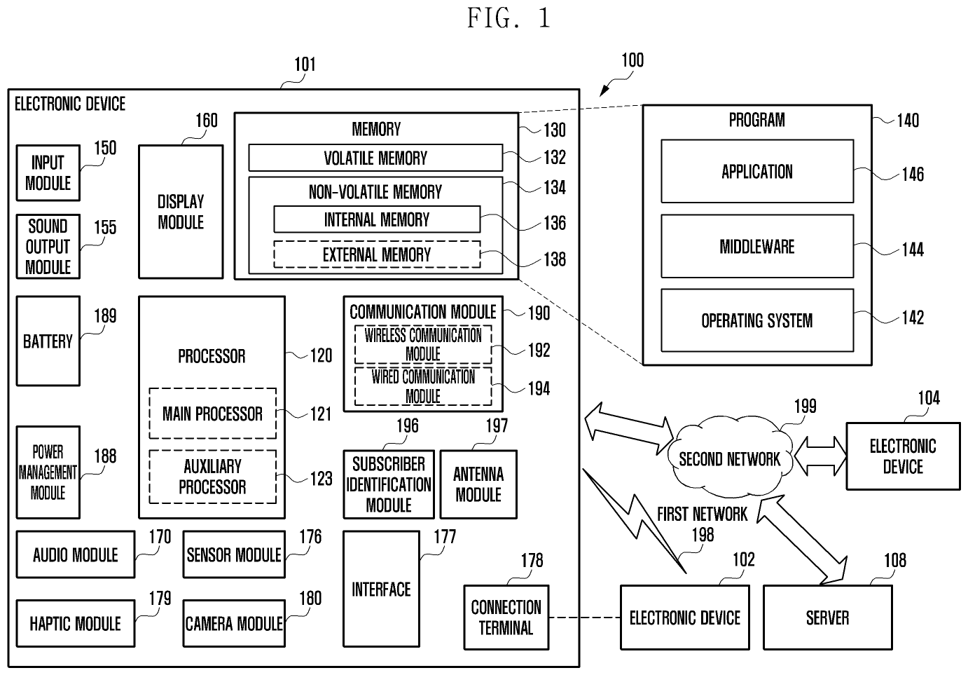

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the 11connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

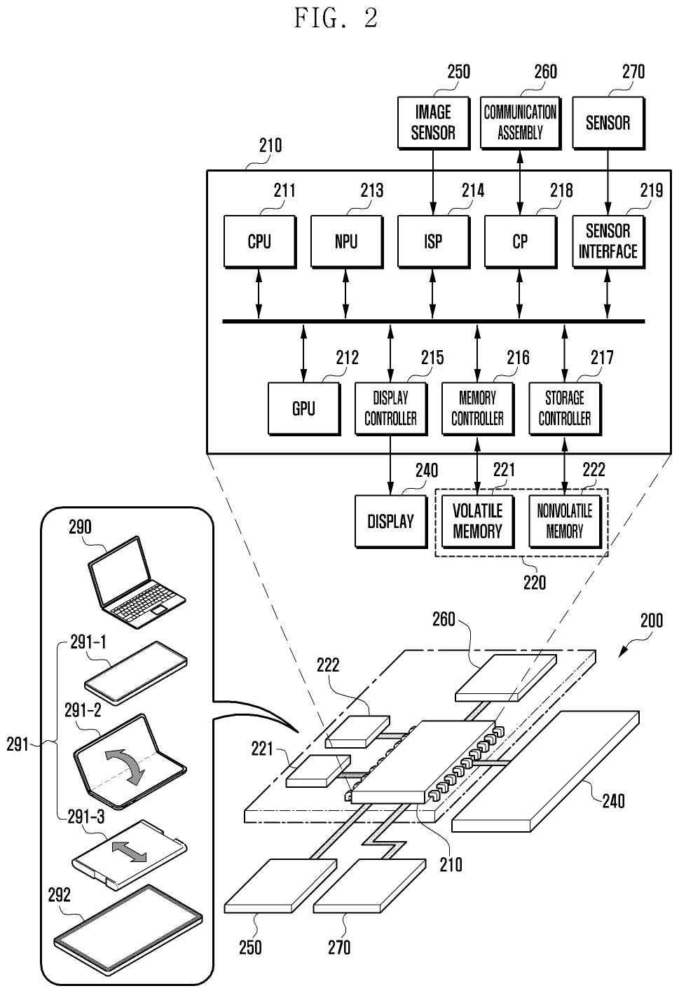

FIG. 2 is a block diagram schematically illustrating a configuration of an electronic device according to an embodiment of the disclosure.

FIG. 2 illustrates a block diagram of an electronic device 200 (e.g., electronic device 101 of FIG. 1) capable of performing the operations described herein.

Referring to FIG. 2, the electronic device 200 may be one of various types of electronic devices, such as a notebook computer 290, smartphones 291 having various form factors (e.g., a bar-type smartphone 291-1, a foldable smartphone 291-2, or a slidable (or rollable) smartphone 291-3), a tablet PC 292, a cellular telephone (not shown), and any other similar computing devices (not shown). The components illustrated in FIG. 2, the relationships thereof, and the functions thereof are merely for illustration, and are not intended to limit the implementations described or claimed in the disclosure thereto. The electronic device 200 may be referred to as a mobile device, a user equipment, a multifunctional device, a portable device, or a server.

According to an embodiment of the disclosure, the electronic device 200 may include all or at least a portion of the components of the electronic device 101 as described in the description that refers to FIG. 1. For example, in various embodiments of the disclosure, some of the illustrated components may be omitted or replaced. The electronic device 200 may include at least a portion of the components and/or functions of the electronic device 101 of FIG. 1. At least a portion of the components of the illustrated (or non-illustrated) electronic device 200 may be operatively, functionally, and/or electrically connected to each other.

The electronic device 200 may comprise various components including at least one processor 210 (e.g., processor 120 of FIG. 1) (hereinafter, the processor 210), at least one memory 220 (e.g., memory 130 of FIG. 1) (hereinafter, the memory 220), at least one display 240 (hereinafter, the display 240), at least one image sensor 250 (hereinafter, the image sensor 250), at least one communication circuitry 260 (hereinafter, the communication circuitry 260), and/or at least one sensor 270 (hereinafter, the sensor 270). The aforementioned components are merely of an example. For example, the electronic device 200 may comprise other components (e.g., a power management integrated circuitry (PMIC), an audio processing circuitry, an antenna, a rechargeable battery, or an input/output interface). For example, some components may be omitted from the electronic device (200). For example, some components may be integrated into one component.

The processor 210 may perform an application layer processing function required by the user of the electronic device 200. According to an embodiment of the disclosure, the processor 210 may provide functional control and instructions for various blocks of the electronic device 200. According to an embodiment of the disclosure, the processor 210 may perform computation or data processing related to control and/or communication of each of the components of the electronic device 200. For example, the processor 210 may include at least a portion of the configuration and/or functions of the processor 120 of FIG. 1. According to an embodiment of the disclosure, the processor 210 may be operatively connected to the components of the electronic device 200. According to an embodiment of the disclosure, the processor 210 may load an instruction or data received from another component of the electronic device 200 to the memory 220, and may process an instruction or data stored in the memory 220 and may store result data.

The processor 210 may be implemented as one or more integrated circuit (or circuitry) (IC) chips and may perform various data processing. The processor 210 may include at least one electrical circuitry and may process instructions (or program, data, and so on) stored in the memory 220 individually or collectively in a distributed manner. The processor 210 may include a processor assembly that includes one or more processing circuitry and/or executable program elements.

The processor may include any processing circuitry that may be operative for controlling operations and performance of one or more components (e.g., the memory 220, a display 240, the image sensor 250, the communication circuitry 260, and/or the sensor 270) of the electronic device. For example, the processor 210 (e.g., an application processor (AP)) may be implemented as a system on chip (SoC) (e.g., one chip or chipset). For example, the processor 210 may be a system semiconductor that is responsible for computation and multimedia driving functions of the electronic device 200. For example, the processor 210 may be implemented as a plurality of cores (or at least one core circuitry), a plurality of chips, or a plurality of chipsets. For example, the processor 210 may comprise one or more processing circuitry. For example, the processor 210 may comprise one or more processing circuitry which are individually and/or collectively configured to perform various functions of the disclosure. As a non-limiting example, at least a portion of the processor 210 may be included in a first chip of the electronic device 200 and at least another portion of the processor 210 may be included in a second chip of the electronic device 200 different from the first chip of the electronic device 200.

For example, the processor 210 may comprise a central processing unit (CPU) 211, a graphics processing unit (GPU) 212, a neural processing unit (NPU) 213, an image signal processor (ISP) 214, a display controller 215, a memory controller 216, a storage controller 217, a communication processor (CP) 218, and/or a sensor interface 219. These components of the processor 210 are merely of an example. For example, the processor 210 may further comprise other components. For example, some components of the processor 210 may be omitted from the processor 210. For example, some components of the processor 210 may be included as separate components of the electronic device 200 outside the processor 210. For example, some components of the processor 210 (e.g., the memory controller 216) may be included in other components of the electronic device 200 (e.g., at least a portion of the memory 220, an interface (e.g., usable for connecting to at least one component of the electronic device 200), the display 240, and/or the image sensor 250).

The processor 210 may cause other components of the electronic device 200 to perform various operations by executing instructions stored in the memory 220.

The CPU 211 (or a central processing circuitry) may be configured to control the components of the processor 210 based on execution of instructions stored in the memory 220 (e.g., the volatile memory 221 and/or the non-volatile memory 222). The CPU 211 may decode an instruction from the user, and may perform arithmetic and logical operations, and/or data processing operations. For example, the CPU 211 may be responsible for functions, such as memory, interpretation, computation, and control. The CPU 211 may execute all software (e.g., application 146 of FIG. 1) of the electronic device 200 on an operating system (OS) and may control a hardware device.

The CPU 211 may store, as at least a portion of data processing or computation, an instruction or data in the volatile memory 221 (e.g., volatile memory 132 of FIG. 1) of the memory 220, and may process the instruction or data stored in the volatile memory 221 and may store result data in the nonvolatile memory 222 (e.g., nonvolatile memory 134 of FIG. 1) of the memory 220.

The CPU 211 may include a single processor core (single core) or may include a plurality of processor cores (multi-core). The CPU 211 may be a programmable processor that may store executable instructions (e.g., instructions capable of performing computation of the CPU 211) and may execute the instructions.

The CPU 211 may operate on a multi-domain. The CPU 211 may operate in a domain of a normal world (e.g., non-secure world, framework, or non-secure environment) and a multi-domain environment of a secure world (e.g., secure framework or secure environment). In an embodiment of the disclosure, the domain of the secure world may include one or more domains (e.g., trusted OS, TrustZone, and/or virtualization framework).

The GPU 212 (or a graphic processing circuitry) may be configured to execute parallel computations (e.g., rendering). The GPU 212 may be responsible for graphic processing. The GPU 212 may receive an instruction from the CPU 211 and may perform graphic processing to express shapes, locations, colors, shading, movement, and/or textures of objects (or things) on the display 240.

The NPU 213 (or a neural processing circuitry, or an artificial intelligence (AI) chip) may be configured to execute operations (e.g., convolution computations) for an artificial intelligence model. The NPU 213 may perform processing optimized for a deep-learning algorithm of artificial intelligence. The NPU 213 is a processor optimized for deep-learning algorithm computation (e.g., artificial intelligence computation) and may process bigdata quickly and efficiently like a human neural network. For example, the NPU 213 may be mainly used for artificial intelligence computation. The NPU 213 may recognize an object, an environment, and/or a person within the background and may automatically adjust the focus when capturing an image through a camera, may automatically switch a capturing mode of the camera when taking a photo of food, and/or may perform processing of erasing only an unnecessary subject from captured results. The NPU 213 may perform processing of generating response content based on given information (e.g., natural language).

The ISP 214 (or an image signal processing circuitry) may be configured to process a raw image obtained from the image sensor 250 in a format suitable for a component in the electronic device 200 or a component of the processor 210. For example, the ISP 214 may be responsible for image processing and correction of an image and a video. The ISP 214 may correct unprocessed data (e.g., raw data) transmitted from the image sensor 250 of the camera (e.g., camera module 180 of FIG. 1) to generate an image in a form more preferred by the user. The ISP 214 may perform postprocessing, such as partially adjusting the brightness of the image and emphasizing details. For example, the ISP 214 may produce results that the user prefers by going through a quality tuning and correcting process of the image acquired through the camera.

The ISP 214 may support artificial intelligence-based image processing technology. The ISP 214 may support scene segmentation (e.g., image segmentation) technology for recognizing and/or classifying parts of a scene being captured in conjunction with the NPU 213. For example, the ISP 214 may include a function of processing objects, such as sky, bushes, and/or skin by applying different parameters to the objects. The ISP 214 may detect and display a human face when capturing an image through an artificial intelligence function, or may adjust the brightness, focus, and/or color of the image using coordinates and information of the face.

According to an embodiment of the disclosure, the electronic device 200 may support integrated machine learning processing by interacting with all processors, such as the CPU 211, the GPU 212, the NPU 213, and the ISP 214.

The display controller 215 (or a display control circuitry, or a display processing unit (DPU)) may be configured to process an image obtained from the CPU 211, the GPU 212, the ISP 214, or the memory 220 (e.g., the volatile memory 221) in a format suitable for the display 240.

The memory controller 216 (or a memory control circuitry) may be configured to control reading data from the volatile memory 221 and writing data to the volatile memory 221.

The storage controller 217 (or a storage control circuitry) may be configured to control reading data from the non-volatile memory 222 and writing data to the non-volatile memory 222.

The CP 218 (or a communication processing circuitry) may be configured to process data obtained from a component of the processor 210 in a format suitable for transmission to another electronic device via the communication circuitry 260, or to process data obtained from another electronic device via the communication circuitry 260 in a format suitable for processing of the component of the processor 210. For example, the communication circuitry 260 may comprise one or more communication circuitry.

The sensor interface 219 (or a sensing data processing circuitry, a sensor hub) may be configured to process data on a state of the electronic device 200 and/or a state around the electronic device 200, obtained through the sensor 270, in a format suitable for a component of the processor 210.

According to an embodiment of the disclosure, the processor 210 may operate in a normal mode (or normal world) and a secure mode (or secure world). According to an embodiment of the disclosure, the processor 210 may control (or process) the overall operation related to providing a secure screen based on de-burn-in (or burn-in compensation), based on processing circuitry and/or executable program element.

According to an embodiment of the disclosure, the processor 210 may generate a de-burn-in layer for a normal screen in a normal mode. According to an embodiment of the disclosure, the processor 210 may identify a switch event to the secure mode in the normal mode. According to an embodiment of the disclosure, the processor 210 may switch from the normal mode to the secure mode in response to the switch event. According to an embodiment of the disclosure, the processor 210 may acquire a de-burn-in layer in the secure mode. According to an embodiment of the disclosure, the processor 210 may display a secure screen to which the de-burn-in layer is applied through at least a portion of the display 240 in the secure mode.

According to an embodiment of the disclosure, the processor 210 may store a de-burn-in layer generated in the normal mode in a first storage portion, and may store the de-burn-in layer stored in the first storage portion in a second storage portion in the secure mode. According to an embodiment of the disclosure, the processor 210 may acquire the de-burn-in layer by loading the de-burn-in layer stored in the second storage portion in the secure mode.

According to an embodiment of the disclosure, the processor 210 may acquire an input related to whether to apply the de-burn-in layer to the secure screen in the secure mode, and may display the secure screen to which the de-burn-in layer is applied based on the input through at least a portion of the display 240.

According to an embodiment of the disclosure, the processor 210 may display the secure screen (e.g., execution screen of secure application) before the de-burn-in layer is applied in the secure mode, and may display a graphical user interface (GUI) (e.g., indicator) for the input on at least a portion of the secure screen before the de-burn-in layer is applied in the secure mode. In an embodiment of the disclosure, the GUI may be configured to include a first option for application of the de-burn-in layer and a second option of nonapplication of the de-burn-in layer, and may be displayed on at least a portion of the secure screen before the de-burn-in layer is applied.

According to an embodiment of the disclosure, the processor 210 may be restricted from receiving a user input through the normal mode in the secure mode.

According to an embodiment of the disclosure, the processor 210 may learn whether to apply the de-burn-in layer to the secure screen based on machine learning or artificial learning. According to an embodiment of the disclosure, the processor 210 may automatically select one secure screen, either the secure screen to which the de-burn-in layer is applied or the secure screen before the de-burn-in layer is applied, based on learning results. According to an embodiment of the disclosure, the processor 210 may display the selected single secure screen through at least a portion of the display 240.

According to an embodiment of the disclosure, the processor 210 may generate a plurality of de-burn-in layers each corresponding to a screen size of the display 240. For example, the processor 120 may generate a first de-burn-in layer corresponding to a first screen size of the display 240 and a second de-burn-in layer corresponding to a second screen size (e.g., screen size larger than first screen size) of the display 240. According to an embodiment of the disclosure, the processor 210 may generate the first de-burn-in layer and the second de-burn-in layer in the secure mode, and may update the de-burn-in layer based on at least one of the first de-burn-in layer and second de-burn-in layer in the normal mode.

According to an embodiment of the disclosure, the processor 210 may generate a plurality of de-burn-in layers (e.g., application-specific de-burn-in layer) each corresponding to an application. For example, the processor 210 may generate a first de-burn-in layer corresponding to a first application and a second de-burn-in layer corresponding to a second application different from the first application. According to an embodiment of the disclosure, the processor 210 may update the de-burn-in layer for the screen based on the first de-burn-in layer or the second de-burn-in layer in response to an application running in the secure mode.

According to an embodiment of the disclosure, the processor 210 may generate the first de-burn-in layer and the second de-burn-in layer as de-burn-in layers for the normal screen in the normal mode. According to an embodiment of the disclosure, the processor 210 may display the secure screen to which the de-burn-in layer is applied through at least a portion of the display 240, based on corresponding one of the first de-burn-in layer and the second de-burn-in layer in the secure mode.

According to an embodiment of the disclosure, the detailed operation of the processor 210 (e.g., processor 120 of FIG. 1) of the electronic device 200 (e.g., electronic device 101 of FIG. 1) will be described with reference to drawings described below.

According to an embodiment of the disclosure, operations performed by the processor 210 may be implemented by executing instructions stored in recording medium (or computer program product or storage medium). For example, the recording medium may include a non-transitory computer-readable recording medium having recorded thereon a program for executing various operations performed by the processor 210.

Embodiments described herein may be implemented within a recording medium readable by a computer or a device similar thereto using software, hardware, or combination thereof. According to hardware implementation, operations described in an embodiment may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or other electrical units for performing functions.

In an embodiment of the disclosure, provided is a computer-readable recording medium (or computer program product) having recorded thereon a program for performing (or executing) various operations in the electronic device 200.

The operations may include an operation of generating a de-burn-in layer for a normal screen in a normal mode (or normal world), an operation of identifying a switch event to a secure mode (or secure world) in the normal mode, an operation of switching from the normal mode to the secure mode in response to the switch event, an operation of acquiring the de-burn-in layer in the secure mode, and an operation of displaying the secure screen (or TUI screen) to which the de-burn-in layer is applied through at least a portion of the display 240 in the secure mode.

The memory 220 may include at least a portion of the configuration and/or functions of the memory 130 of FIG. 1, and may store software (e.g., program 140 of FIG. 1 and/or application 146 of FIG. 1). The memory 220 may comprise one or more storage mediums (or one or more storage devices). For example, the memory 220 may include a memory assembly that includes one or more storage mediums. For example, the one or more storage mediums may comprise a permanent memory (e.g., the non-volatile memory 222), such as hard drive, flash memory, read-only memory (ROM), semi-permanent memory (e.g., the volatile memory 221), such as random access memory (RAM), storage (or a storage assembly) of any other suitable type, or any combination thereof.

The memory 220 may comprise a cache memory which is memory of one or more different types used to store data for performing a function or feature of the electronic device 200 at least temporarily. As a non-limiting example, the cache memory may be included in the processor 210.

The memory 220 may be fixedly embedded within the electronic device 200, or may be incorporated onto one or more suitable types of components that may be repeatedly inserted into the electronic device 200, and removed from the electronic device 200 (e.g., a subscriber identity module (SIM) card, and/or a secure digital (SD) card).

For example, the memory 220 may store one or more software applications, such as an operating system (or a system) software application, a firmware software application, a driver software application, a plug-in (e.g., add-in, add-on, and/or applet) software application, and/or any other suitable software application. For example, the one or more software applications may include instructions executable by the processor 210. For example, the memory 220 may store instructions callable by an application programming interface (API). For example, the memory 220 may store instructions in a library.

The memory 220 may store a variety of data used by at least one component (e.g., processor 210) of the electronic device 200. In an embodiment of the disclosure, data may include input data or output data for software (e.g., program 140 of FIG. 1) (e.g., operating system 142, middleware 144, and/or application 146 of FIG. 1), and an instruction (command) related to the software.

The memory 220 may include the volatile memory 221 (e.g., volatile memory 132) or the nonvolatile memory 222 (e.g., nonvolatile memory 134 of FIG. 1). The memory 220 may store an instruction or data received from the processor 210 in the volatile memory 221, and may store, in the nonvolatile memory 222, result data that is acquired by processing the instruction or data stored in the volatile memory 221 through the processor 210.

In an embodiment of the disclosure, the data stored in the memory 220 may include the de-burn-in layer. In an embodiment of the disclosure, the de-burn-in layer may be data generated for compensation (e.g., burn-in compensation or de-burn-in) for a residual image or burn-in phenomenon of the display 240. In an embodiment of the disclosure, the de-burn-in layer may be referred to as a burn-in compensation map, a burn-in compensation map image, a burn-in compensation layer, a burn-in compensation parameter, or a burn-in compensation algorithm.

According to an embodiment of the disclosure, the memory 220 may include at least one storage that includes the first storage portion corresponding to the normal mode and the second storage portion corresponding to the secure mode. The first storage portion and the second storage portion may be different areas in a single storage, or may be separate storages. According to an embodiment of the disclosure, data (e.g., de-burn-in layer) generated in the normal mode may be stored in the first storage portion. According to an embodiment of the disclosure, data (e.g., de-burn-in layer) stored in the first storage portion may be stored in the second storage portion in the secure mode. According to an embodiment of the disclosure, when the first storage portion and the second storage portion are configured as a single storage, data stored in the second storage portion may not be retrieved in the normal mode.

In an embodiment of the disclosure, data (e.g., de-burn-in layer) may include various learning data and/or parameters acquired based on learning of the user through interaction with the user. In an embodiment of the disclosure, data (e.g., de-burn-in layer) may include various schemas (or algorithms, models, networks, or functions) to support artificial intelligence-based operations.

In an embodiment of the disclosure, artificial intelligence technology may be applied in various fields. For example, the fields may include the technical fields of linguistic understanding, visual understanding, inference/prediction, knowledge representation, and/or operation control. Linguistic understanding refers to technology for recognizing and applying/processing human language/text, and may include natural language processing, machine translation, conversational system, question-and-answer, and/or voice recognition/synthesis. Visual understanding refers to technology for recognizing and processing an object like human vision, and may include object recognition, object tracking, image search, person recognition, scene understanding, spatial understanding, and/or image enhancement. Inference/prediction refers to technology for performing logical inference and prediction by determining information, and may include knowledge/probability-based inference, optimization prediction, preference-based planning, and/or recommendation. Knowledge representation refers to technology for automatically processing human experience information to knowledge data, and may include knowledge construction (e.g., data generation/classification) and/or knowledge management (e.g., data utilization). Operation control refers to technology for controlling the movement of the electronic device 200, and may include movement control and/or manipulation control (e.g., action control).

For example, the schema to support the artificial intelligence-based operation in the electronic device 200 may include a neural network. In an embodiment of the disclosure, the neural network may include a neural network model based on at least one of an artificial neural network (ANN), a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network (DN), a deep belief network (DBN), restricted Boltzman machine (RBM), a long short-term memory (LSTM) network, a classification network, a plain residual network, a dense network, a hierarchical pyramid network, and/or a fully convolutional network. According to an embodiment of the disclosure, types of the neural network model are not limited to the above-described examples.

According to an embodiment of the disclosure, at the time of execution, the memory 220 may include instructions that, when individually and/or collectively executed by the processor 210, cause the electronic device 200 to perform the operation.

According to an embodiment of the disclosure, the memory 220 may store instructions that, when individually and/or collectively executed by the processor 210, cause the electronic device 200 to generate a de-burn-in layer for a normal screen in a normal mode, to identify a switch event to a secure mode in the normal mode, to switch from the normal mode to the secure mode in response to the switch event, to acquire the de-burn-in layer in the secure mode, and to display a secure screen to which the de-burn-in layer is applied through at least a portion of the display 240 in the secure mode.

According to an embodiment of the disclosure, instructions may be stored as software (e.g., program 140 of FIG. 1) in the memory 220, and may be executed by the processor 210. For example, the instructions may include a control instruction, such as arithmetic and logical operation, data transfer, and/or input/output that may be recognized by the processor 210. According to an embodiment of the disclosure, software may include various applications (e.g., application 146 of FIG. 1) that may provide various functions (or services) (e.g., conversational service function, routine function, call function, message function, messenger function, email function, social networking service (SNS) function, search function, media (e.g., video and/or music) playback function, game function, and/or wireless communication function) in the electronic device 200.

The display 240 may include the configuration identical or similar to the display module 160 of FIG. 1. The display 240 may display various images provided from the processor 210. The display 240 may visually provide an executed application (e.g., application 146 of FIG. 1) and various screens related to use of the application (e.g., contents screen, application execution screen, menu screen, and/or function execution screen) under control of the processor 210. According to an embodiment of the disclosure, the display 240 may display the normal screen corresponding to the normal mode (or normal world) and the secure screen (or TUI screen) corresponding to the secure mode (or secure world).

According to an embodiment of the disclosure, a screen size of the display 240 may be changed depending on a form factor of the electronic device 200 (e.g., bar-type smartphone 291-1, foldable-type smartphone 291-2, or slidable (or rollable)-type smartphone 291-3, tablet 292). For example, the display 240 may be configured to provide a first state having a first screen size and a second state having a second screen size larger than the first screen size. According to an embodiment of the disclosure, burn-in compensation may be applied based on a different de-burn-in layer (e.g., first de-burn-in layer and second de-burn-in layer) depending on the screen size and/or display area of the display 240.

According to an embodiment of the disclosure, the electronic device 200 may include an electronic device (e.g., including multi-foldable electronic device) in the same form as a foldable electronic device (e.g., foldable-type smartphone 291-2). For example, the electronic device 200 may be a foldable electronic device in various types, such as G-type, Z-type, or e-type. According to an embodiment of the disclosure, when the electronic device 200 is in the form of the multi-foldable electronic device, the electronic device 200 may include a first housing, a second housing, and a third housing. According to an embodiment of the disclosure, as in a case in which the first housing is folded or a case in which the first housing and the third housing are folded together in the first housing, the second housing, and the third housing, the electronic device 200 may provide a different de-burn-in layer (or burn-in compensation map, burn-in compensation layer, burn-in compensation parameter, or burn-in compensation algorithm) according to a state (or size of displayed screen (or screen display area) (e.g., flex state (or intermediate mode)) of the display 240 of the electronic device 200. For example, a de-burn-in layer in an area being folded (e.g., folding area) of the display 240 may differ from a de-burn-in layer of a non-folding area (e.g., general area) of the display 240.

In an embodiment of the disclosure, the operation in a case in which the electronic device is the foldable electronic device is an example only and does not limit implementations described or claimed herein, and the implementation of the disclosure may be implemented in various devices, such as a wearable device, a home appliance, an extended reality (XR) (e.g., virtual reality (VR), augmented reality (AR), and mixed reality (MR)) device, and/or a vehicle, equipped with a trusted execution environment (TEE) operating system (OS).

The display 240 may be combined with a touch sensor, a pressure sensor capable of measuring the intensity of touch, and/or a touch panel (e.g., digitizer) that detects a stylus pen of a magnetic field method. The display 240 may detect a touch input, an air gesture input, and/or a hovering input (or proximity input) by measuring a change in signal (e.g., voltage, light intensity, resistance, electromagnetic signal, and/or charge) at a specific location of the display 240 based on the touch sensor, the pressure sensor, and/or the touch panel. For example, the display 240 may include a touchscreen that detects a touch and/or a proximity touch (or hovering) input using a part of the user's body (e.g., finger) or an input device (e.g., stylus pen).

The display 240 may include a liquid crystal display (LCD), a light-emitting diode (LED) display, an organic LED (OLED) display, and/or an active matrix OLED (AMOLED) display, a micro electro mechanical systems (MEMS) display, or an electronic paper display, but is not limited thereto. According to an embodiment of the disclosure, the display 240 may include a flexible display.

The communication circuitry 260 may support establishment of a designated wireless communication (e.g., short-range communication, such as Bluetooth communication and/or Bluetooth low energy (BLE) communication) channel and performance of communication through the established wireless communication channel. For example, the communication circuitry 260 may perform designated communication (e.g., Bluetooth communication and/or BLE communication) with an external device. The communication circuitry 260 may support wireless communication with the external device using cellular wireless communication (e.g., 4G LTE, 5G NR) and/or short-range wireless communication (e.g., Wi-Fi). For example, the electronic device 200 may communicate with an external server (e.g., generative artificial intelligence server) that provides an artificial intelligence-based function (e.g., conversational service, or assistant service, or AI agent) over the network, using the communication circuitry 260. According to an embodiment of the disclosure, the communication circuitry 260 may transmit data generated from the electronic device 200 to the external server and may receive data transmitted from the external server. The communication circuitry 260 may include at least a portion of the configuration and/or functions of the communication module 190 of FIG. 1.

In an embodiment of the disclosure, the electronic device 200 may include the artificial intelligence-based function (e.g., conversational service, or assistant service, or AI agent) in an AI module (e.g., including processing circuitry) within the electronic device 200. For example, the AI module may be operatively combined with at least one processor (e.g., processor 120 or processor 210) of the electronic device 200. For example, the AI module may be operatively combined with a sensor (e.g., senor module 176, sensor 270, or sensor interface 219) of the electronic device 200 for one or more sensors within the electronic device 200.

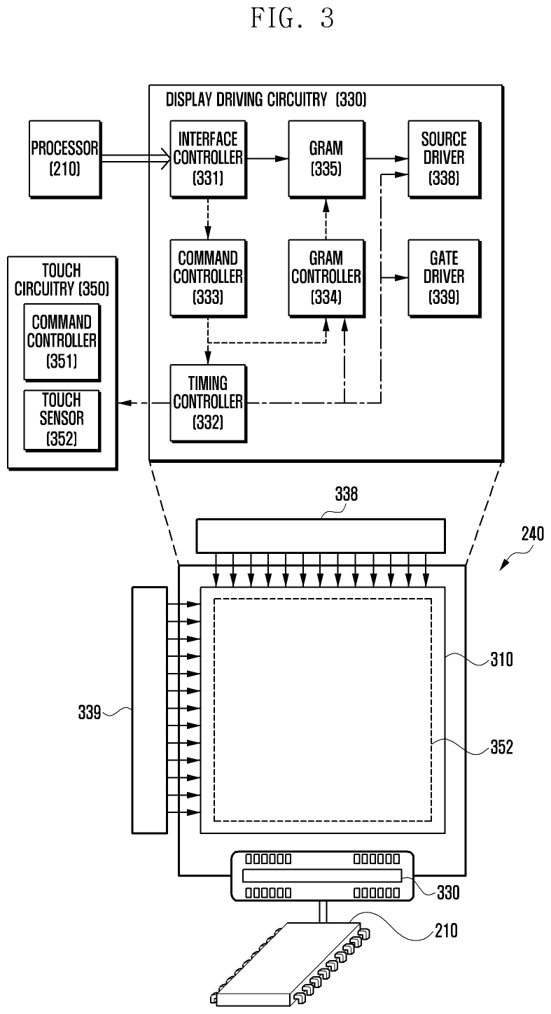

FIG. 3 illustrates a display according to an embodiment of the disclosure.

Referring to FIG. 3, the display 240 may comprise a display having a fixed shape and/or a deformable display, such as e.g., a foldable display or a rollable (or slidable) display. The components illustrated in FIG. 3, their relationships, and their functions are only and are not intended to limit the implementations described or claimed in the disclosure.

The display 240 may comprise components, such as e.g., a display panel 310, display driver integrated circuitry (DDI) 330 (or display driver circuitry 330), and/or touch circuitry 350. These components are only. For example, the display 240 may comprise other components (e.g., circuitry for controlling a digitizer and/or a sensor 270). For example, some components may be omitted from the display 240.

The display panel 310 may include a plurality of pixels and a plurality of thin film transistors (TFTs) controlling the plurality of pixels. For example, the plurality of TFTs may include p-channel metal-oxide semiconductor (PMOS) transistors and/or n-channel metal-oxide semiconductor (NMOS) transistors. Each of the plurality of pixels may include a set of subpixels (e.g., a subpixel for providing red light, a subpixel for providing blue light, a subpixel for providing green light, and/or a subpixel for providing white light). For example, the plurality of pixels within the display panel 310 may be driven based on a voltage (or current) provided to the TFTs via (or from) the display drive circuitry 330.

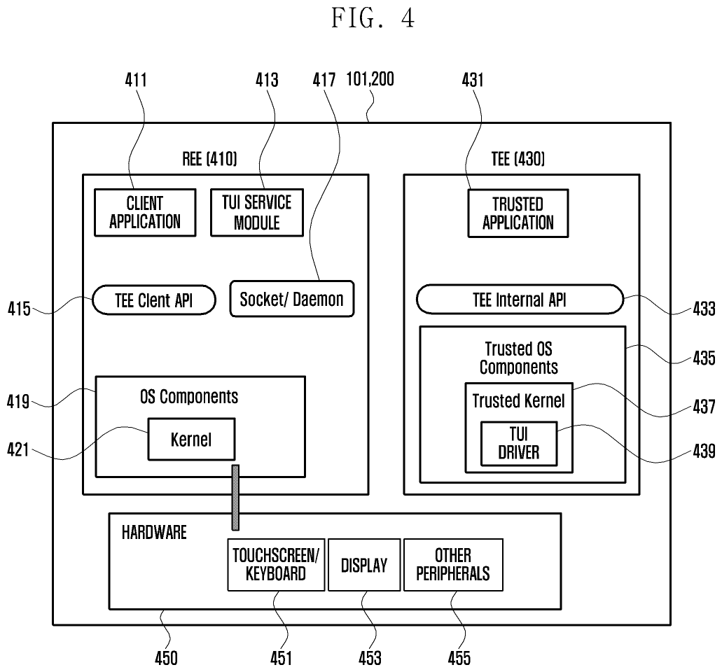

The display drive circuitry 330 may provide visual information via the display panel 310, based on image data and/or commands to control the operation of subcomponents of the display drive circuitry 330, received from the processor 210. The display drive circuitry 330 may comprise subcomponents, such as e.g., an interface controller 331 (e.g., including an interface controlling circuitry), a timing controller 332 (e.g., including a timing controlling circuitry), a command controller 333 (e.g., including a command controlling circuitry), a graphics random access memory (GRAM) controller 334 (e.g., including a GRAM controlling circuitry), a GRAM 335, a source driver 338, and/or a gate driver 339. The display driving circuitry 330 may be configured to receive data (e.g., frame data) from the processor 210 and to control the display panel 310 to display visual information using the data. The display driving circuitry 330 may be described as a display peripheral (e.g., display 453 of FIG. 4).

These subcomponents are only. For example, the display drive circuitry 330 may further comprise other subcomponents (e.g., a self-drawing engine (or any suitable circuitry for a self-drawing)). For example, some subcomponents (e.g., the GRAM controller 334 and the GRAM 335) may be omitted from the display drive circuitry 330. For example, some subcomponents (e.g., the source driver 338, the gate driver 339, or the like) may be disposed as separate components from the display drive circuitry 330.

The interface controller 331 may provide the image data obtained from the processor 210 (e.g., a display controller 215) to the GRAM 335 and provide the commands obtained from the processor 210 to the command controller 333. For example, the interface controller 331 may be used for one or more interfaces (e.g., a mobile industry processor interface (MIPI), a mobile display digital interface (MDDI), a serial peripheral interface (SPI), an inter-integrated circuit (I2C), and/or a compact display port (CDP)). According to an embodiment of the disclosure, the image data may be stored in the GRAM 335. According to an embodiment of the disclosure, storing the image data in the GRAM 335 may be bypassed. If the storing the image data is to be bypassed, the image data may be provided to an image processing circuit (not shown) or the source driver 338 in the display drive circuitry 330 via the interface controller 331.

The timing controller 332 may provide a synchronization signal (or a timing signal) to the GRAM controller 334, the source driver 338, and/or the gate driver 339. According to an embodiment of the disclosure, the synchronization signal may be generated by the timing controller 332, and the synchronization signal generated by the timing controller 332 may be provided from the timing controller 332 to the GRAM controller 334, the source driver 338, the gate driver 339, and/or the touch circuitry 350. According to an embodiment of the disclosure, the synchronization signal may be generated by a synchronization signal generation circuit located out of the display drive circuitry 330, and may be provided to the timing controller 332 from the synchronization signal generation circuit.

The synchronization signal supplied by the synchronization signal generation circuit may be provided from the timing controller 332 to the GRAM controller 334, the source driver 338, and/or the gate driver 339. For example, the synchronization signal may include display synchronization signals (e.g., a display vertical synchronization signal and display horizontal synchronization signal). For example, the display vertical synchronization signal and the display horizontal synchronization signal may be utilized for reference timing switching each of the source driver 338 and the gate driver 339. For example, the synchronization signal may include touch synchronization signals (e.g., a touch vertical synchronization signal and a touch horizontal synchronization signal). For example, each of the touch vertical synchronization signal and the touch horizontal synchronization signal may be provided to the touch circuitry 350. As a non-limited example, a frequency of the display synchronization signal may be different from a frequency of the touch synchronization signal.

The command controller 333 may provide the commands to the GRAM controller 334 and/or the timing controller 332.

The GRAM controller 334 may provide the image data to the source driver 338, by scanning the image data recorded in the GRAM 335 based on the synchronization signal obtained from the timing controller 332 and the command obtained from the command controller 333. According to an embodiment of the disclosure, the image data may be processed by an image processing circuit (not shown) located between the GRAM 335 and the source driver 338, based on the commands provided to the image processing circuit from the command controller 333, before being provided to the source driver 338.

The source driver 338 may provide a color through the set of subpixels, based on the display vertical synchronization signal and the image data. For example, the source driver 338 may provide, to the plurality of pixels, a data voltage corresponding to the input image data.

The gate driver 339 may turn the set of sub-pixels on or off, based on the display horizontal synchronization signal and a light emission signal.

The touch circuitry 350 may comprise a touch sensor controller 351 and a touch sensor 352.

The touch sensor controller 351 may control the touch sensor 352 based on the touch synchronization signals (e.g., the touch vertical synchronization signal and/or the touch horizontal synchronization signal) to obtain information about an input on the display panel 310 (e.g., a touch input or a hovering input on the display panel 310). The touch sensor controller 351 may provide the information obtained based on the touch synchronization signal to the processor 210 or the display drive circuitry 330.

The touch sensor 352 may be disposed in association with the display panel 310. For example, the touch sensor 352 may be disposed in the display panel 310, or may be disposed on the display panel 310.

According to an embodiment of the disclosure, the electronic device 200 may provide an independent secure execution environment between data or services stored in the electronic device 200. For example, the electronic device 200 may perform an operation of preventing hacking from the outside through software and hardware security in the process of performing user authentication, when providing a service, such as biometric recognition, mobile ID, and/or payment of the electronic device 200. For example, the electronic device 200 may provide an independent secure execution environment for device security to strengthen the security of the electronic device 200 itself and a security service based on user information, such as mobile ID, payment, and a car key in the electronic device 200.

FIG. 4 is a diagram illustrating providing of a user interface (e.g., trusted user interface (TUI)) in a secure execution environment (TEE) of an electronic device according to an embodiment of the disclosure.

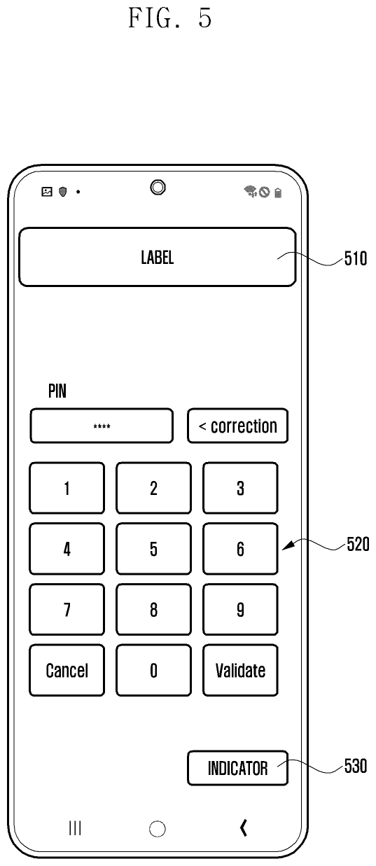

FIG. 5 illustrates a secure screen in an electronic device according to an embodiment of the disclosure.

Referring to FIGS. 4 and 5, according to an embodiment of the disclosure, the electronic device 101, 200 (hereinafter, referred to as electronic device 101) supports a multi-security architecture/framework as a secure environment within the electronic device 101 diversifies. For example, as TrustZone is added to a secure framework in addition to a multi-secure environment, the electronic device 101 may support a multi-domain (or framework) within the electronic device 101. Such an environment may be defined as a multi-domain environment. Hereinafter, an example of providing a user interface in the multi-domain environment is described.

In an embodiment of the disclosure, TrustZone may represent technology for providing two separate environments to the processor 120, 210 (hereinafter, referred to as processor 120) (e.g., CPU 211 of FIG. 2) to safely protect information that requires security in an isolated environment. TrustZone provides a secure and non-secure isolated environment that may provide confidentiality and integrity by separating the processor 120 (e.g., CPU 211), address space, and the memory 130, 220 (hereinafter, referred to as memory 130) as hardware units. For example, all resources of the electronic device 101 may be designed to be accessible only on an appropriate driver and application according to their intended usage.

For example, TrustZone may be a separate area (e.g., embedded secure element (eSE), secure processor) other than the processor 120. For example, TrustZone may be a secure area developed by ARM™ (e.g., TrustZone™). For example, TrustZone may be implemented as a hypervisor.

Referring to FIG. 4, TrustZone may be separated into a rich execution environment (REE) 410 that is a normal execution area (e.g., normal world) and a trusted execution environment (TEE) 430 that is a secure execution area (e.g., secure world). The TEE 430 may access all resources of the TEE 430 and the REE 410, and the REE 410 may access only resources of the REE 410. For example, the TEE 430 may be a general term for a processor with a separated secure area within the electronic device 101 and may represent a secure area (or trusted environment) that may safely process an operation requiring a high level of security.

The TEE 430 may execute all sensitive tasks within a trusted application (TA) 431 (or TEE application) running in the TEE 430 through a TEE internal API 433. However, a specific application may need to expose sensitive information to the user to acquire verification or sensitive information from the user. To this end, the electronic device 101 may provide a trusted user interface (TUI) based on the TEE 430. The TUI may provide a hardware-isolated trusted environment suitable for secure input and secure display of the sensitive information. Access to a TUI service module 413 is only possible in the trusted application (TA) 431. Therefore, general sensitive data may be processed only in the TEE 430 may not be accessible outside the TEE 430. For example, the basic goal of the TUI may be to provide the user with a trusted input and output environment and to secure interaction based on this.

Referring to FIG. 4, a general architecture that constitutes the TUI may include hardware 450 (or platform HW), such as a touchscreen/keyboard) 451, a display 453 (and/or display controller), and/or other peripherals 455 (or other trusted peripherals). In a secure mode, if a TUI-based TUI screen (or secure screen) is displayed on the display 453, the hardware 450 should not be able to be read or written in the REE 410 and related event indication should not be received in the REE 410. In an embodiment of the disclosure, whether to return the control right of the corresponding hardware 450 to the REE 410 or whether to provide some other methods for the REE 410 to access the hardware 450 may vary depending on implementation of a specific platform or the specific TEE 430. Hereinafter, a TUI entry and initialization process in a client application 411 (e.g., Samsung wallet) is described.

Referring to FIG. 4, the electronic device 101 (e.g., client application 411) may open a TUI session by calling a TEE client API 415. The electronic device 101 may allocate and initialize a TUI driver 439 during the opening of the TUI session. The electronic device 101 may perform socket communication through a socket of Socket/Daemon 417, may start a TUI service by the TUI service module 413 in the REE 410 through Daemon (e.g., tzdaemon), and may transfer the kernel driver control right of a kernel 421 (e.g., OS kernel) of OS components 419 to the TEE 430) (e.g., trusted kernel 437 within trusted OS components 435).

The electronic device 101 may load the TUI driver 439 of the TEE 430. Then, the electronic device 101 may control the corresponding hardware 450 (e.g., display and/or display driver) through the TUI driver 439.

Hereinafter, the operation after TUI initialization and entry is described with reference to FIG. 4.

Referring to FIG. 4, the electronic device 101 may bind the TUI service module 413 in the client application 411 and may start TUI activity. The electronic device 101 may process events related to the client application 411 and power key, back key, cancel key, and/or incall key by transmitting the same to the TUI service module 413, or may process the events by transmitting the same to the trusted OS components 435 of the TEE 430 through the TEE client API 415.

For example, FIG. 5 may represent an example of a secure screen (or TUI screen) (e.g., PIN pad screen or biometric authentication (e.g., fingerprint authentication) screen) provided by the electronic device 101. For example, the electronic device 101 may switch to the TUI screen (e.g., PIN pad screen) through the TEE client API 415. As exemplified in FIG. 5, if input of a PIN button is received through the TUI screen provided in the TEE 430 after switching to the TUI screen (or during TUI session), the electronic device 101 may process image drawing or touch input according to the input of the PIN button in the trusted application 431 through the TEE internal API 433. According to an embodiment of the disclosure, when an image is being drawn, the electronic device 101 may draw and update the corresponding image by controlling the display 453 in a display driver (e.g., DDI) of the TEE 430 through the TEE client API 415.

In an embodiment of the disclosure, FIG. 5 may represent an example in which a PIN pad screen is displayed as an example of screen configuration of the TUI. As exemplified in FIG. 5, the TUI may include a label 510 (e.g., identifier of executed application, for example, brand information, PIN-related content, or biometric authentication-related content), an execution screen 520 (e.g., PIN pad screen or biometric authentication screen) of an application corresponding to the label 510, and/or an indicator 530. In an embodiment of the disclosure, the indicator 530 indicates a secure mode (or execution state of secure mode) and may be implemented by various GUIs.

The electronic device 101 may allow the TEE 430 to display a screen for the user through the TUI internal API 433. In an embodiment of the disclosure, the TUI may provide basic security aspects, such as secure display, secure input, and/or secure indicator to achieve the screen display.

Secure display may prevent any software within the REE 410 or an unauthenticated application of the TEE 430 to access, modify, or display information displayed for the user. For example, this may include protecting and clearing a frame buffer, protecting a display device, and protecting TUI resources (e.g., button image, keypad image).

Secure input may prevent any software within the REE 410 or the unauthenticated application of the TEE 430 to derive or modify information input from the user. For example, this may include protecting a touch device.

Secure indicator may be provided to ensure that the user is aware that the screen being displayed is actually a screen displayed by the trusted application 431. For example, when TUI session display through the dedicated hardware 450 (e.g., LED controlled only in the TEE 430) or the hardware 450 is unavailable, display may be provided through the user's personal information or a dedicated image.

The TUI described above may provide effects, such as strengthening system security, protecting sensitive information, and securing reliability. The TUI may support protecting the system from, for example, a malicious code in terms of strengthening the system security. In terms of strengthening the system security, the TUI may improve safety of the system by minimizing security threats that may occur during a process of receiving user input and providing output, for example. In terms of protecting sensitive information, the TUI may support secure processing of sensitive tasks (e.g., bill payment, money transfer, or document signature verification) in financial services or corporate environments, for example. In terms of securing reliability, the TUI operates inside, for example, the TEE 430, so the results are highly reliable, which makes the user be confident that the user's data is being processed safely.

Meanwhile, as exemplified in FIG. 5, the TUI may be displayed through the display (e.g., display 240 of FIG. 2) of the electronic device 101. However, the display 453 (e.g., OLED display) may have an issue that it is vulnerable to burn-in, such as discoloration. In general, in the REE 410, screen compensation is provided to prevent a burn-in screen by periodically capturing user screen data, by generating a de-burn-in layer from the accumulated results and storing the same in the memory 130, 220 (e.g., flash memory), and by transmitting the same to an internal memory of the DDI (e.g., display driving circuitry 330 of FIG. 3) through a burn-in service module of an operating system (OS).

On the other hand, in the TEE 430, since a display window is separated and is output as a raw image directly from the TEE 430, the TEE 430 may not compensate for burn-in phenomenon of the display 453. Therefore, when de-burn-in (or burn-in removal) is not performed on the TUI (or TUI screen), the user may experience an issue in terms of UX in which that the user's look and feel for the screen is not unified. For example, due to the burn-in issue, when discoloration of the display 453 occurs, a normal screen may appear normally as a compensation screen, but if compensation is not provided to the TUI, it may appear as a burn-in screen during TUI entry or execution. For example, an undesirable residual image (or residual image) may be displayed on the TUI screen.

In the disclosure, the TEE 430 may also apply, to the TUI, and provide a de-burn-in layer. For example, due to constraints of the TUI, the de-burn-in layer in the normal world may not be applied to the TUI, so a burn-in compensation screen was disallowed. However, through the disclosure, the burn-in phenomenon may be prevented on the secure screen by safely acquiring the de-burn-in layer and applying the same to the TUI.

An electronic device (e.g., electronic device 101, 200 of FIG. 1 or FIG. 2) (hereinafter, referred to as electronic device 101) according to an embodiment of the disclosure may include a display (e.g., display module 160 of FIG. 1, display 240 of FIG. 2 or FIG. 3) (hereinafter, referred to as display module 160), at least one processor (e.g., processor 120 of FIG. 1, processor 210 of FIG. 2 or FIG. 3) (hereinafter, referred to as processor 120) including processing circuitry, and memory (e.g., memory 130, 220 of FIG. 1 or FIG. 2) (hereinafter, referred to as memory 130). In an embodiment of the disclosure, the memory 130, when individually and/or collectively executed by the processor 120, may store instructions to cause the electronic device 101 to perform the operation. In an embodiment of the disclosure, the processor 120 may operate in a normal mode (or normal world) and a secure mode (e.g., secure world). In an embodiment of the disclosure, the display module 160 may display a normal screen corresponding to the normal mode and a secure screen corresponding to the secure mode.

According to an embodiment of the disclosure, the instructions, when individually and/or collectively executed by the processor 120, may cause the electronic device 101 to generate a de-burn-in layer for the normal screen in the normal mode. The instructions, when individually and/or collectively executed by the processor 120, may cause the electronic device 101 to identify a switch event to the secure mode in the normal mode. The instructions, when individually and/or collectively executed by the processor 120, may cause the electronic device 101 to switch from the normal mode to the secure mode in response to the switch event. The instructions, when individually and/or collectively executed by the processor 120, may cause the electronic device 101 to acquire the de-burn-in layer in the secure mode. The instructions, when individually and/or collectively executed by the processor 120, may cause the electronic device 101 to display the secure screen to which the de-burn-in layer is applied through at least a portion of the display in the secure mode.

According to an embodiment of the disclosure, the electronic device 101 may include at least one storage that includes a first storage portion corresponding to the normal mode and a second storage portion corresponding to the secure mode.

According to an embodiment of the disclosure, the instructions, when individually and/or collectively executed by the processor 120, may cause the electronic device 101 to store the generated de-burn-in layer in the first storage portion in the normal mode. The instructions, when individually and/or collectively executed by the processor 120, may cause the electronic device 101 to store the de-burn-in layer stored in the first storage portion in the second storage portion in the secure mode. The instructions, when individually and/or collectively executed by the processor 120, may cause the electronic device 101 to perform an operation of acquiring the de-burn-in layer by loading the de-burn-in layer stored in the second storage portion in the secure mode.

According to an embodiment of the disclosure, the instructions, when individually and/or collectively executed by the processor 120, may cause the electronic device 101 to verify the de-burn-in layer in the secure mode. The instructions, when individually and/or collectively executed by the processor 120, may cause the electronic device 101 to perform an operation of displaying the secure screen to which the de-burn-in layer is applied through at least a portion of the display based on the verification.

According to an embodiment of the disclosure, the instructions, when individually and/or collectively executed by the processor 120, may cause the electronic device 101 to store the de-burn-in layer in the second storage portion based on the verification.

According to an embodiment of the disclosure, the instructions, when individually and/or collectively executed by the processor 120, may cause the electronic device 101 to perform the verification by identifying that forgery is absent in data of the de-burn-in layer between a point in time of storing the de-burn-in layer in the second storage portion and a point in time of loading the de-burn-in layer from the second storage portion.

According to an embodiment of the disclosure, the instructions, when individually and/or collectively executed by the processor 120, may cause the electronic device 101 to perform the verification by signing the de-burn-in layer with a signing key corresponding to the secure screen.

According to an embodiment of the disclosure, the instructions, when individually and/or collectively executed by the processor 120, may cause the electronic device 101 to acquire a user input related to whether to apply the de-burn-in layer to the secure screen in the secure mode. The instructions, when individually and/or collectively executed by the processor 120, may cause the electronic device 101 to perform an operation of displaying the secure screen to which the de-burn-in layer is applied through at least a portion of the display based on the user input, in the secure mode.

According to an embodiment of the disclosure, the instructions, when individually and/or collectively executed by the processor 120, may cause the electronic device 101 to display another secure screen before the de-burn-in layer is applied in the secure mode. The instructions, when individually and/or collectively executed by the processor 120, may cause the electronic device 101 to display a GUI for the user input on at least a portion of the other secure screen before the de-burn-in layer is applied in the secure mode.

According to an embodiment of the disclosure, the instructions, when individually and/or collectively executed by the processor 120, may cause the electronic device 101 to perform an operation of displaying the GUI on at least a portion of the other secure screen before the de-burn-in layer is applied, such that the GUI includes a first option for application of the de-burn-in layer and a second option for nonapplication of the de-burn-in layer.

According to an embodiment of the disclosure, the instructions, when individually and/or collectively executed by the processor 120, may cause the electronic device 101 to perform an operation of displaying the secure screen to which the de-burn-in layer is applied through at least a portion of the display when the first option is selected by the user input. The instructions, when individually and/or collectively executed by the processor 120, may cause the electronic device 101 to display the other secure screen before the de-burn-in layer is applied when the second option is selected by the user input.

According to an embodiment of the disclosure, the instructions, when individually and/or collectively executed by the processor 120, may cause the electronic device 101 to disallow the user input to be received through the normal mode in the secure mode.

According to an embodiment of the disclosure, the instructions, when individually and/or collectively executed by the processor 120, may cause the electronic device 101 to learn whether to apply the de-burn-in layer to the secure screen through machine learning or artificial intelligence. The instructions, when individually and/or collectively executed by the processor 120, may cause the electronic device 101 to automatically select a single secure screen between the secure screen to which the de-burn-in layer is applied and another secure screen before the de-burn-in layer is applied, based on the learning results, and to display the selected single secure screen through at least a portion of the display.

According to an embodiment of the disclosure, the instructions, when individually and/or collectively executed by the processor 120, may cause the electronic device 101 to display an indicator indicating the secure mode on at least a portion of the secure screen in the secure mode.

According to an embodiment of the disclosure, the switch event may include a payment request in a financial application.

According to an embodiment of the disclosure, the instructions, when individually and/or collectively executed by the processor 120, may cause the electronic device 101 to generate and store a plurality of de-burn-in layers corresponding to a plurality of states of the display and/or a plurality of de-burn-in layers corresponding to a plurality of applications. According to an embodiment of the disclosure, the instructions, when individually and/or collectively executed by the processor 120, may cause the electronic device 101 to acquire the de-burn-in layer based on a state of the display and/or an executed application among the plurality of de-burn-in layers.

According to an embodiment of the disclosure, the instructions, when individually and/or collectively executed by the processor 120, may cause the electronic device 101 to generate another de-burn-in layer for the secure screen in the secure mode. The instructions, when individually and/or collectively executed by the processor 120, may cause the electronic device 101 to update the de-burn-in layer based on the other de-burn-in layer in the normal mode.

According to an embodiment of the disclosure, the display module 160 may be configured to provide a first state having a first screen size and a second state having a second screen size larger than the first screen size.

According to an embodiment of the disclosure, the instructions, when individually and/or collectively executed by the processor 120, may cause the electronic device 101 to generate a first de-burn-in layer corresponding to the first state and a second de-burn-in layer corresponding to the second state as the other de-burn-in layers in the secure mode. The instructions, when individually and/or collectively executed by the processor 120, may cause the electronic device 101 to perform an operation of updating the de-burn-in layer based on at least one of the first de-burn-in layer and the second de-burn-in layer in the normal mode.

According to an embodiment of the disclosure, the instructions, when individually and/or collectively executed by the processor 120, may cause the electronic device 101 to generate a first de-burn-in layer corresponding to the first state and a second de-burn-in layer corresponding to the second state as the de-burn-in layers for the normal screen in the normal mode. The instructions, when individually and/or collectively executed by the processor 120, may cause the electronic device 101 to perform an operation of displaying the secure screen to which the de-burn-in layer is applied through at least a portion of the display, based on corresponding one of the first de-burn-in layer and the second de-burn-in layer in the secure mode.

Hereinafter, an operating method of the electronic device 101, 200 (hereinafter, referred to as electronic device 101) of various embodiments is described below. Operations performed by the electronic device 101 according to various embodiments may be performed by at least one processor 120, 210 (hereinafter, referred to as processor 120) including various processing circuitry and/or executable program elements of the electronic device 101. According to an embodiment of the disclosure, operations performed by the electronic device 101 may be stored in the memory 130, 220 (hereinafter, referred to as memory 130) as instructions, and may be individually and/or collectively performed by the processor 120.

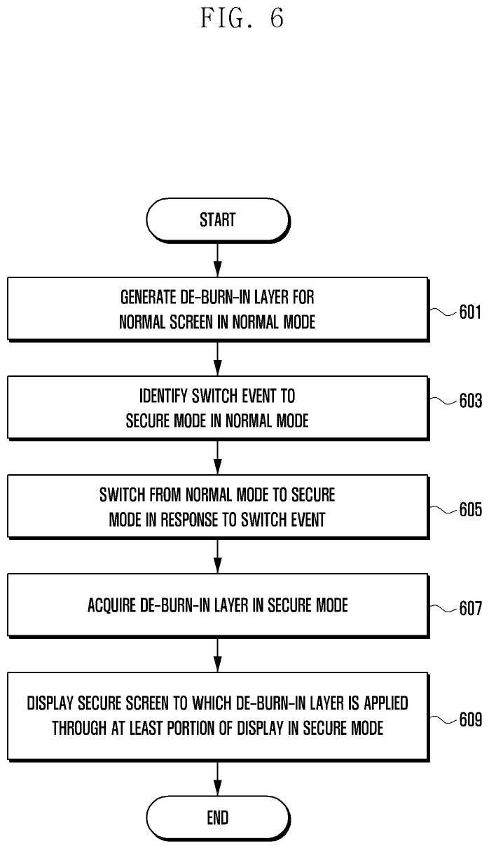

FIG. 6 is a flowchart illustrating an operating method of an electronic device according to an embodiment of the disclosure of the disclosure.

According to an embodiment of the disclosure, FIG. 6 may represent an example of a method of providing a de-burn-in-based secure screen in the electronic device 101 according to an embodiment.

A method of providing a secure screen in the electronic device 101 according to an embodiment of the disclosure may be performed, for example, according to the flowchart illustrated in FIG. 6. The flowchart illustrated in FIG. 6 is an example according to an embodiment of the operation of the electronic device 101, the order of at least some operations may be changed or performed in parallel, or may be performed as independent operations. Alternatively, at least some other operations may be performed complementarily to at least some operations. According to an embodiment of the disclosure, operations 601 to 609 may be performed by the at least one processor 120 of the electronic device 101.

Referring to FIG. 6, the operating method performed by the electronic device 101 according to an embodiment may include generating a de-burn-in layer for a normal screen in a normal mode at operation 601, identifying a switch event to a secure mode in the normal mode at operation 603, switching from the normal mode to the secure mode in response to the switch event at operation 605, acquiring the de-burn-in layer in the secure mode at operation 607, and displaying a secure screen to which the de-burn-in layer is applied through at least a portion of a display in the secure mode at operation 609.

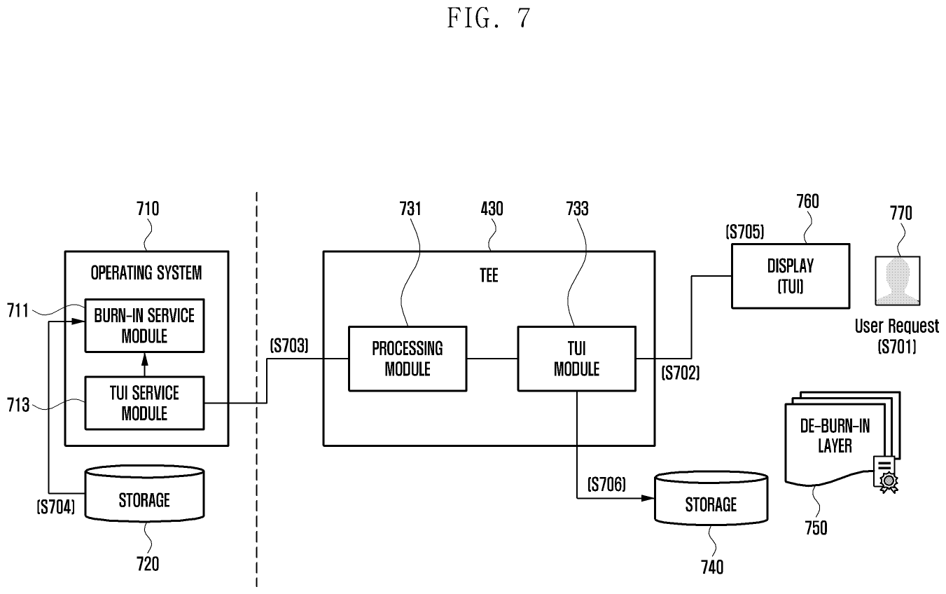

Referring to FIG. 6, in operation 601, the processor 120 of the electronic device 101 may generate the de-burn-in layer for the normal screen in the normal mode. For example, the processor 120 may capture user screen data periodically (e.g., about 1 hour, about 24 hours, or the like) in the REE 410 and may generate the de-burn-in layer from the accumulated results. For example, the processor 120 may receive a request for generating the de-burn-in layer from the user and may generate the de-burn-in layer in response to the user request. According to an embodiment of the disclosure, the de-burn-in layer may be stored in a storage (e.g., storage (e.g., storage 720 of FIG. 7) of the REE 410 that stores data in the normal mode.

In operation 603, the processor 120 may identify the switch event to the secure mode in the normal mode. In an embodiment of the disclosure, the switch event may relate to executing a secure application (e.g., financial application, browser, pay application, and/or health application). For example, it may include a request for authentication data and/or payment in the financial application, a request for personal information lookup and/or payment information in the browser, a request for authentication data and/or payment in a pay application, or a request for personal information lookup in the health application.

In an embodiment of the disclosure, when the electronic device 101 is a point-of-sale (POS) terminal used for payment with a physical card (e.g., credit card or debit card) or supports a POS function, switching to (or executing) the secure mode may include a situation in which the identity of a physical card user needs to be verified in the process in which transaction is being performed by entering a PIN number of the physical card user. In an embodiment of the disclosure, switching to (or executing) the secure mode may include a situation in which user authentication is required in a short message service (SMS)/multimedia message service (MMS) message, an email, and/or instant message.

In an embodiment of the disclosure, switching to (or executing) the secure mode may include a situation in which control over an access to health data and/or history of the user (e.g., patient) in a health application and/or medical device is required (e.g., personal information inquiry request). In an embodiment of the disclosure, switching to (or executing) the secure mode may include a situation in which the TUI is used to identify the user’ identity or to ensure the security of information in a web service of a system of a public institution (e.g., government system) or an internal system, such as tax reporting and/or resident registration information inquiry. In an embodiment of the disclosure, switching to (or executing) the secure mode may include a situation in which the electronic device 101 requires protection of the user's information according to access to the user's personal schedule and/or task information in an organizer (e.g., schedule management application).

In operation 605, the processor 120 may switch from the normal mode to the secure mode in response to the switch event.

In operation 607, the processor 120 may acquire the de-burn-in layer in the secure mode. According to an embodiment of the disclosure, in the secure mode, the processor 120 may load the de-burn-in layer (e.g., recent de-burn-in layer) generated in the normal mode and stored in the storage 720.

In operation 609, the processor 120 may display the secure screen to which the de-burn-in layer is applied through at least a portion of the display 240 in the secure mode. According to an embodiment of the disclosure, the processor 120 may verify the de-burn-in layer in the secure mode and may display the secure screen to which the de-burn-in layer is applied through at least a portion of the display 240 based on the verification. According to an embodiment of the disclosure, the processor 120 may store the de-burn-in layer in a storage (e.g., storage (e.g., TEE storage 740 of FIG. 7) of TEE 430) that stores data in the secure mode based on the verification.

FIG. 7 illustrates an operation of applying burn-in compensation to a secure screen in an electronic device according to an embodiment of the disclosure.

Referring to FIG. 7, an example of an operation between a component (or architecture) and a component for burn-in compensation on a secure screen (or TUI screen) is illustrated.

Referring to FIG. 7, an architecture (or framework) of the electronic device 101 may be divided into two worlds (or modes), such as a normal world (or normal mode or non-secure world) and a secure world (or secure mode or secure environment or secure framework). For example, the two worlds may provide a multi-domain environment, such as a domain of the normal world and a domain of the secure world.

In an embodiment of the disclosure, the normal world may include an operating system (OS) 710 (e.g., Android OS) and a storage 720 (or first storage or general storage). The operating system 710 may include a burn-in service module 711 and a trusted UI (TUI) service module 713.

In an embodiment of the disclosure, the secure world may include the TEE 430 (e.g., TEE 430 of FIG. 4) that is a trusted environment and the storage 740 (or second storage or TEE storage). The TEE 430 may include a processing module 731 and a trusted UI (TUI) module 733.

The TUI module 733 may be a component that operates in the TEE 430 and provides a TUI function of providing an input device to a user 770. For example, previously, in the TEE 430, a screen touch device was provided to the user 770 after configuring and displaying image information on a screen. Therefore, there may be a lack of consistency in terms of UX L&F (look and feel) with the screen of the normal world (e.g., normal screen corresponding to normal world (or normal mode)). However, in the disclosure, even in the TEE 430, UX L&F may be unified from the screen of the normal world (or normal screen) to the screen of the secure world (or secure screen or TUI screen) by inputting a de-burn-in layer 750 (or burn-in compensation map or burn-in compensation layer or burn-in compensation parameter or burn-in compensation algorithm) to a DDI (e.g., DDI 330 of FIG. 3) within a display 760. In an embodiment of the disclosure, the DDI 330 may be configured to access both the REE (e.g., REE 410 of FIG. 4) and the TEE 430 to output image information on the screen, and may be configured to display, on the display 760, the compensated screen (e.g., TUI) by receiving the de-burn-in layer 750.

The TUI service module 713 is driven in the REE (e.g., REE 410 of FIG. 4) and may be a component capable of communicating with both the burn-in service module 711 being driven in the REE 410 and the TUI module 733 being driven in the TEE 430.

The burn-in service module 711 may be a component that periodically captures the screen, and generates, stores, and/or updates the de-burn-in layer 750 for burn-in compensation. In an embodiment of the disclosure, as the de-burn-in layer 750, a plurality of de-burn-in layers corresponding to a plurality of states (or size of displayed screen or screen display area) of the display of the electronic device 101 and/or a plurality of de-burn-in layers corresponding to a plurality of applications may be generated and stored. For example, as the de-burn-in layer 750, a plurality of de-burn-in layers for the respective states of the display of the electronic device 101 (e.g., de-burn-in layers respectively corresponding to states of display) may be generated and stored. In an embodiment of the disclosure, as the de-burn-in layer 750, the plurality of de-burn-in layers for the respective applications (e.g., de-burn-in layers respectively corresponding to applications) may be generated and stored.

The storage 720 may be a component that stores data in the REE 410.

The TEE storage 740 may be a component that stores data in the TEE 430.

Referring to FIG. 7, an example of an operation of displaying the secure screen (or TUI screen) to which the de-burn-in layer 750 is applied for burn-in compensation through at least a portion of the display 760 in the electronic device 101 is described.

Referring to FIG. 7, the electronic device 101 may execute an application (or secure application) that requires user authentication (or verification), and may display a screen of the application (e.g., secure screen or TUI screen) (e.g., PIN pad screen or biometric authentication (e.g., fingerprint authentication) screen) on the display 760. According to an embodiment of the disclosure, the TUI module 733 may receive an input for requesting de-burn-in (or burn-in compensation) of the secure screen from the user 770, while displaying the secure screen (or TUI screen) on the display 760 (S701). In an embodiment of the disclosure, the electronic device 101 may provide a method that may request de-burn-in to the user 770, and may receive an input for de-burn-in based on the corresponding method. For example, the electronic device 101 may provide a designated indicator (e.g., text, icon, image, and/or software button) on the screen, and may receive an input (e.g., tap) that requests de-burn-in through the designated indicator. For example, the electronic device 101 may provide a designated physical button of the electronic device 101 for a function for de-burn-in, and may receive an input (e.g., click) that requests de-burn-in through the designated physical button.

If de-burn-in for the secure screen is requested by the user 770, the TUI module 733 may request the TUI service module 713 for the de-burn-in layer 750 (S702).

In response to the request from the TUI module 733, the TUI service module 713 may request the burn-in service module 711 for the de-burn-in layer 750 (S703).

In response to the request from the TUI service module 733, the burn-in service module 711 may acquire the de-burn-in layer 750 from the storage 720 (S704). The burn-in service module 711 may transmit the acquired de-burn-in layer 750 to the TUI module 733. In an embodiment of the disclosure, the storage 720 may store one or more de-burn-in layers 750 for each defined application. In an embodiment of the disclosure, in response to the request from the TUI service module 733, the burn-in service module 711 may acquire the de-burn-in layer 750 corresponding to the application (e.g., application for current TUI screen). In an embodiment of the disclosure, when the number of de-burn-in layers 750 corresponding to the application is plural, the burn-in service module 711, the burn-in service module 711 may operate to acquire a recently updated de-burn-in layer.

The TUI module 733 may transmit the de-burn-in layer 750 transmitted from the burn-in service module 711 to the display 760 (e.g., DDI of display 760) to perform compensation processing for the secure screen (or TUI screen) (S705). For example, the TUI module 733 may display the secure screen to which the de-burn-in layer 750 is applied using the secure screen of the secure application and the de-burn-in layer 750.

According to an embodiment of the disclosure, the electronic device 101 may provide the user 770 with a method that may determine whether to approve the de-burn-in effects, and may receive an input related to whether to approve the de-burn-in effects based on the corresponding method. For example, the electronic device 101 may provide a designated indicator (e.g., text, icon, image, and/or software button) on the screen, and may receive an input (e.g., tap) that requests de-burn-in through the designated indicator. For example, the electronic device 101 may provide a designated physical button of the electronic device 101 for a function for de-burn-in, and may receive an input (e.g., click) that requests de-burn-in through the designated physical button.

According to an embodiment of the disclosure, the electronic device 101 may receive a user input related to whether to apply the de-burn-in layer 750 to the secure screen in the secure mode, and may display the secure screen to which the de-burn-in layer 750 is applied through at least a portion of the display 760 based on the user input in the secure mode. For example, the electronic device 101 may display another secure screen before the de-burn-in layer 750 is applied in the secure mode, and may display a GUI (or indicator) for the user input through at least a portion of the other secure screen before the de-burn-in layer 750 is applied in the secure mode. In an embodiment of the disclosure, the GUI indicates an execution state of the secure mode, and may be implemented by various GUIs. According to an embodiment of the disclosure, the GUI may include a first option for application of the de-burn-in layer 750 and a second option for nonapplication of the de-burn-in layer 750. According to an embodiment of the disclosure, the GUI may be displayed on at least a portion of the other secure screen before the de-burn-in layer 750 is applied. According to an embodiment of the disclosure, when the first option is selected by the user input, the electronic device 101 may display the secure screen to which the de-burn-in layer 750 is applied through at least a portion of the display 760. According to an embodiment of the disclosure, when the second option is selected by the user input, the electronic device 101 may display the other secure screen before the de-burn-in layer 750 is applied. According to an embodiment of the disclosure, the electronic device 101 may be restricted from receiving the user input through the normal mode in the secure mode.

If the user 770 approves the de-burn-in effects, the TUI module 733 may sign the de-burn-in layer 750 with a defined signing key (e.g., TEE signing key) and may store the same in the TEE storage 740 (S706). The electronic device 101 may separately store the de-burn-in layer 750 in the TEE storage 740, such that the TEE 430 may directly make a compensation when the de-burn-in layer 750 is required in the secure screen.

According to an embodiment of the disclosure, the electronic device 101 may verify the de-burn-in layer 750 in the secure mode, and may display the secure screen to which the de-burn-in layer 750 is applied through at least a portion of the display 760 based on the verification. According to an embodiment of the disclosure, the electronic device 101 may store the de-burn-in layer 750 in the TEE storage 740 based on the verification. According to an embodiment of the disclosure, the electronic device 101 may to perform the verification by identifying that forgery is absent in data of the de-burn-in layer 750 between a point in time of storing the de-burn-in layer 750 in the TEE storage 740 and a point in time of loading the de-burn-in layer 750 from the TEE storage 740. According to an embodiment of the disclosure, the electronic device 101 may perform the verification by signing the de-burn-in layer 750 with a signing key (e.g., TEE signing key) corresponding to the secure mode.

If the user 770 rejects the de-burn-in effects, the TUI module 733 may cancel the de-burn-in effects and may display the secure screen (or TUI screen) on which the de-burn-in effects are canceled. In an embodiment of the disclosure, if the de-burn-in effects are rejected, the TUI module 733 may discard the de-burn-in layer 750 transmitted from the burn-in service module 711 without storing the same in the storage 740.

Referring to FIG. 7, FIG. 7 may represent an example of an operation of requesting the final judgement through direct and explicit intervention of the user 770 in determining whether to apply the de-burn-in effects to the secure screen (or TUI screen). This is to protect image information of the TUI screen from attack of a malicious hacker since data (or parameter) corresponding to the de-burn-in layer 750 is generated in the normal world with vulnerable security from the perspective of the TEE 430. Additionally, as a result of applying the de-burn-in effects, the TUI screen provided to the user 770 may cause confusion in the user 770's input operation compared to before the de-burn-in effects are applied, so the final judgement through direct and explicit intervention of the user 770 may be required in determining whether to apply the de-burn-in effects to the TUI screen.

In an embodiment of the disclosure, although FIG. 7 describes an example of applying a de-burn-in layer based on user intervention, it is only an example and does not limit implementations described or claimed herein. For example, as described herein, implementations of the disclosure may operate by automatically determining whether to apply the de-burn-in layer by the electronic device 101 (e.g., processor 120, artificial intelligence, and/or instructions) without user intervention.

According to an embodiment of the disclosure, in relation to providing the secure screen based on the de-burn-in layer, whether to apply the de-burn-in layer may be automatically determined and applied by the electronic device 101 (e.g., processor 120, artificial intelligence, and/or instructions) without user intervention. For example, the electronic device 101 may identify the switch event based on the processor 120 and/or artificial intelligence, may select a de-burn-in layer corresponding (or defined) to a state of the electronic device 101 (e.g., state of display or size of displayed screen or screen display area) and/or an executed application among the defined plurality of de-burn-in layers in response to the switch event, and may update the screen based on the selected de-burn-in layer (e.g., update de-burn-in layer).

According to an embodiment of the disclosure, in relation to providing the secure screen based on the de-burn-in layer, whether to apply the de-burn-in layer may be applied based on the user's selection through interaction with the user. For example, the electronic device 101 may identify the switch event based on the processor 120 and/or artificial intelligence, and may provide a guide that allows the user to select whether to apply the de-burn-in layer in response to the switch event. According to an embodiment of the disclosure, the electronic device 101 may select a de-burn-in layer corresponding (or defined) to a state of the electronic device 101 (e.g., state of display or size of displayed screen or screen display area) and/or an executed application among the defined plurality of de-burn-in layers and may provide the selected de-burn-in layer to the user (e.g., display a guide screen), and in response to the user's confirmation regarding whether to apply the de-burn-in layer, may update the screen based on the selected de-burn-in layer (e.g., apply de-burn-in layer), or may display the screen without updating the de-burn-in layer.

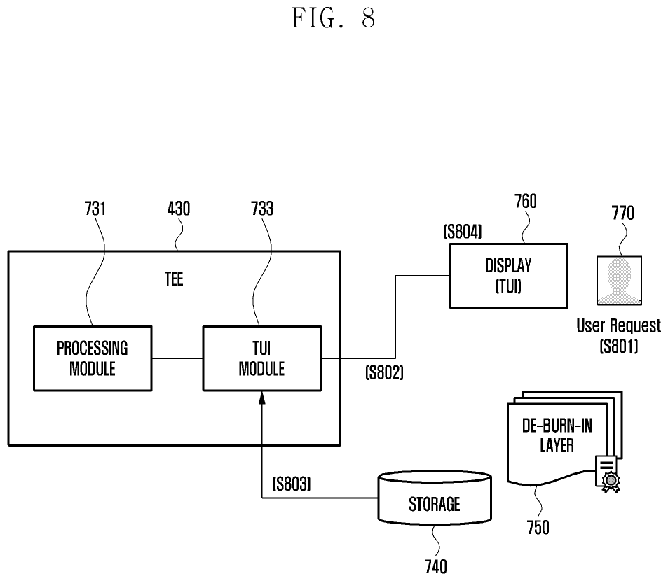

FIG. 8 illustrates an operation of supporting burn-in compensation on a secure screen in an electronic device according to an embodiment of the disclosure.

According to an embodiment of the disclosure, as exemplified in FIG. 7, FIG. 8 may represent an example of an operation in which the TEE 430 autonomously applies burn-in compensation (or de-burn-in) after signing the de-burn-in layer 750 with a defined signing key (e.g., TEE signing key) and storing the same in the TEE storage 740 (S706).

Referring to FIG. 8, the TUI module 733 may receive an input that requests de-burn-in (or burn-in compensation) of the secure screen from the user 770 while displaying the secure screen (or TUI screen) on the display 760 (S801).

If a request for de-burn-in for the secure screen is received from the user 770 (S802), the TUI module 733 may verify and then acquire the de-burn-in layer 750 stored in the TEE storage 740 (S803). Here, the verification of the de-burn-in layer 750 may indicate verifying the integrity (or integrity) of data using the TEE signing key. For example, verification may be an operation of identifying whether forgery is present in data (e.g., de-burn-in layer 750) between a timepoint of storing the data (e.g., de-burn-in layer 750) and a timepoint of retrieving the stored data (e.g., de-burn-in layer 750).

The TUI module 733 may transmit the de-burn-in layer 750 transmitted from the TEE storage 740 to the DDI of the display 760, and the display 760 may perform compensation processing for the secure screen (or TUI screen) and may automatically display the secure screen (or TUI screen) in which burn-in is corrected (8804).

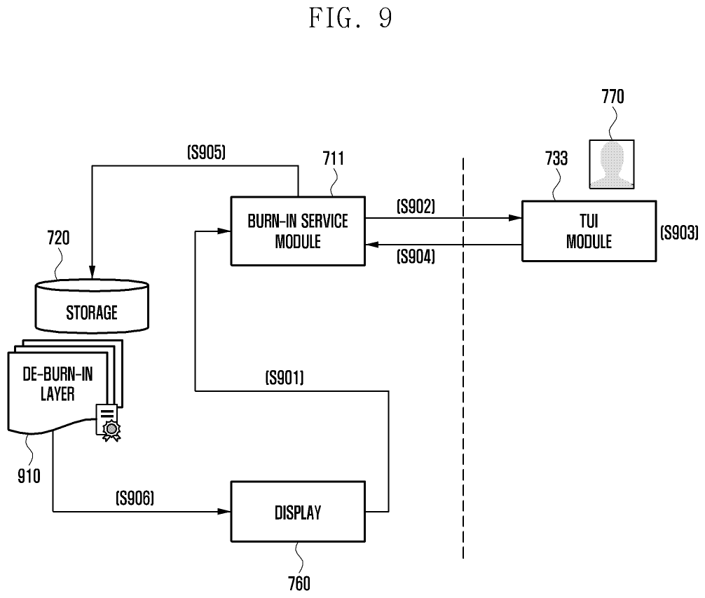

FIG. 9 illustrates utilizing of a de-burn-in layer in an electronic device according to an embodiment of the disclosure.

Referring to FIG. 9, it may represent an example of an operation of safely applying the de-burn-in effects using the de-burn-in layer even in the REE 410. For example, from the perspective of the TEE 430, it may be assumed that data of the normal world is fundamentally unsafe. Therefore, as exemplified in FIG. 7, the de-burn-in layer stored in the TEE storage 740 through the process of storing the de-burn-in layer in the TEE storage 740 (8706) may be a secure de-burn-in layer that is confirmed by the user 770 and signed with the TEE signing key. On the other hand, a de-burn-in layer that is generated and used in the normal world may not be safe. The unsafe de-burn-in layer may have vulnerability that allows the normal screen of the normal world to be tampered with attack of a malicious hacker.

Referring to FIG. 9, the burn-in service module 711 may generate a de-burn-in layer 910 by capturing the screen of the display 760 (8901).

The burn-in service module 711 may request the user 770 to approve (verify) the generated de-burn-in layer 910, while transmitting the same to the TUI module 733 (8902).

If approval of the user 770 for the requested de-burn-in layer 910 is acquired, the TUI module 733 may sign the approved de-burn-in layer 910 with the TEE signing key (8903), and may transmit the same to the burn-in service module 711 (8904).

The burn-in service module 711 may store, in the storage 720, the de-burn-in layer 910 of which TEE signing is completed (e.g., safe de-burn-in layer) (S905).

The electronic device 101 may apply the de-burn-in effects even in the normal screen displayed on the display 760 using the safe de-burn-in layer stored in the storage 720 (S906).

According to an embodiment of the disclosure, the electronic device 101 may generate the de-burn-in layer (e.g., safe de-burn-in layer) for the secure screen in the secure mode, and may update the de-burn-in layer in the normal mode based on the de-burn-in layer (e.g., safe de-burn-in layer) generated in the secure mode.

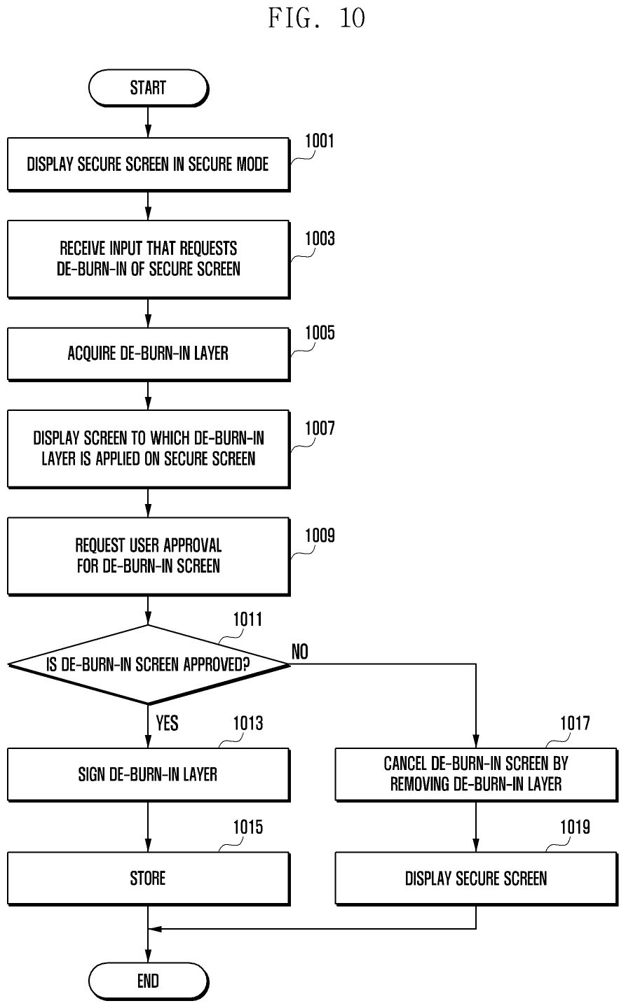

FIG. 10 is a flowchart illustrating an operating method of an electronic device according to an embodiment of the disclosure.

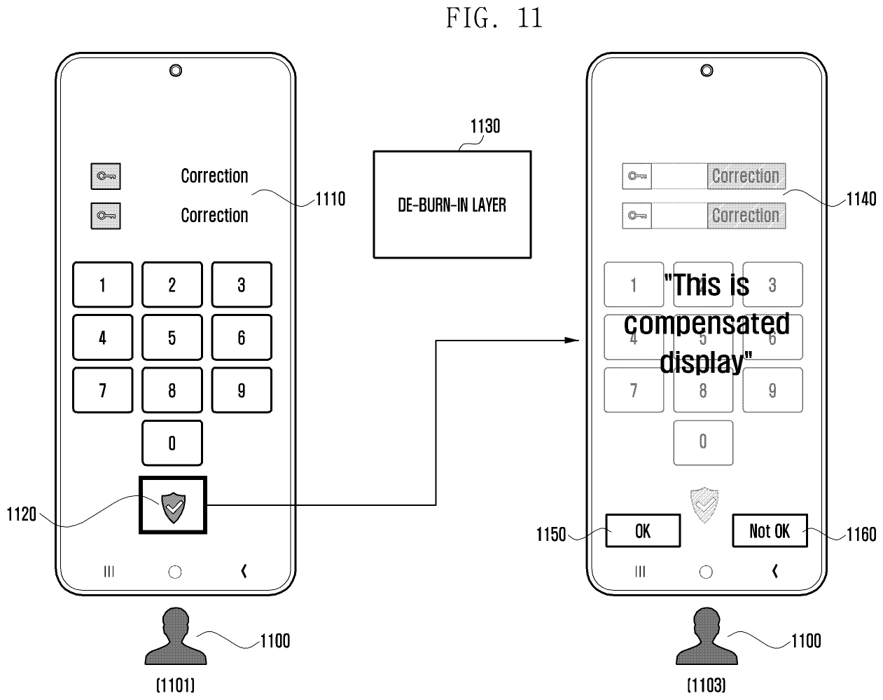

FIG. 11 illustrates providing a TUI screen in an electronic device according to an embodiment of the disclosure.

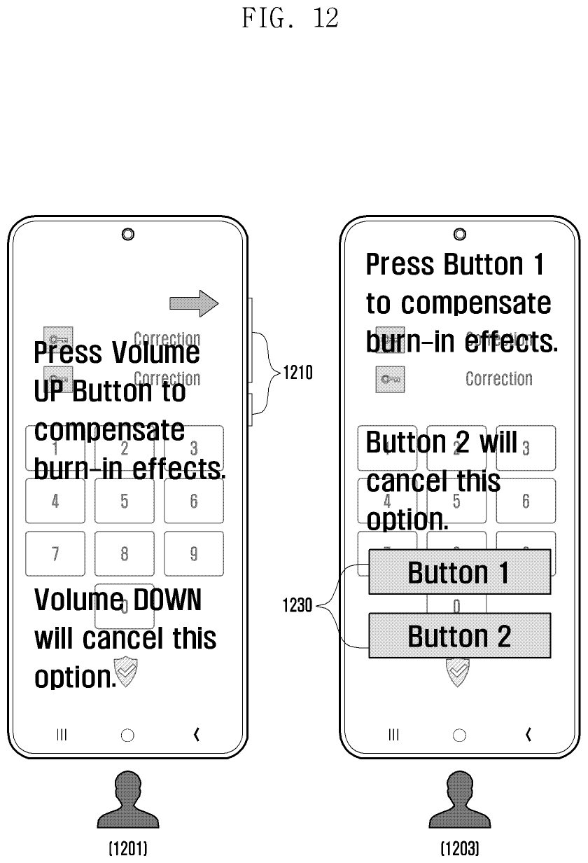

FIG. 12 illustrates providing a TUI screen in an electronic device according to an embodiment of the disclosure.

Referring to FIG. 10, it may represent an example of a method of applying de-burn-in to a secure screen in the electronic device 101 according to an embodiment.

A method of applying de-burn-in to the secure screen in the electronic device 101 according to an embodiment of the disclosure may be performed, for example, according to the flowchart illustrated in FIG. 10. The flowchart illustrated in FIG. 10 is an example according to an embodiment of the operation of the electronic device 101, and the order of at least some operations may be changed or performed in parallel, or may be performed as independent operations. Alternatively, at least some other operations may be performed complementarily to at least some operations. According to an embodiment of the disclosure, operations 1001 to 1019 may be performed by the at least one processor 120 of the electronic device 101.

According to an embodiment of the disclosure, the operation described in FIG. 10 may be performed heuristically, for example, in combination with the operations described in FIGS. 6 to 9, or may be performed heuristically by replacing at least some of the operation described above and combining with at least some other operations, or may be performed heuristically as a detailed operation of at least some of the operations described above.

As illustrated in FIG. 10, an operating method performed by the electronic device 101 according to an embodiment may include displaying a secure screen in a secure mode at operation 1001, receiving an input that requests de-burn-in of the secure screen at operation 1003, acquiring a de-burn-in layer at operation 1005, displaying a de-burn-in screen to which the de-burn-in layer is applied on the secure screen at operation 1007, requesting user approval for the de-burn-in screen at operation 1009, and determining whether the user approves the de-burn-in screen at operation 1011, signing the de-burn-in layer based on the user's approval acquired for the de-burn-in screen at operation 1013, storing the signed de-burn-in layer at operation 1015, canceling the de-burn-in screen by removing the de-burn-in layer based on the user's rejection acquired for the de-burn-in screen at operation 1017, and displaying the secure screen before the de-burn-in screen at operation 1019.

Referring to FIG. 10, in operation 1001, the processor 120 of the electronic device 101 may display the secure screen in the secure mode. An example of this is illustrated in FIG. 11. According to an embodiment of the disclosure, as exemplified in example <1101> of FIG. 11, the processor 120 may display a secure screen 1110 (or TUI screen) (e.g., PIN pad screen) of an executed application (e.g., financial application) on a display.

In operation 1003, the processor 120 may receive the input that requests de-burn-in of the secure screen. An example of this is illustrated in FIG. 11. According to an embodiment of the disclosure, FIG. 11 may represent an example of an operation of requesting the user for de-burn-in while displaying the TUI screen on the display in the electronic device 101 (e.g., TUI module 733). According to an embodiment of the disclosure, with reference to FIG. 11, as exemplified in example <1101>, the processor 120 may display a determined indicator 1120 on the screen, and may identify whether to apply de-burn-in to the currently displayed secure screen 1110 (e.g., update de-burn-in layer 1130 for secure screen 1110) through the indicator 1120. According to an embodiment of the disclosure, a user 1100 may request application of de-burn-in (e.g., update of de-burn-in layer 1130) based on selecting the indicator 1120 (e.g., touch gesture input of selecting (e.g., clicking) indicator 1120).

In an embodiment of the disclosure, the indicator 1120 indicates an execution state of the secure mode and may be implemented by various GUIs. According to an embodiment of the disclosure, the GUI may include a first option for application of the de-burn-in layer 1130 and a second option for nonapplication of the de-burn-in layer 1130. According to an embodiment of the disclosure, the GUI may be displayed on at least a portion of the secure screen 1110 before the de-burn-in layer 1130 is applied.

In operation 1005, the processor 120 may acquire the de-burn-in layer 1130. According to an embodiment of the disclosure, the processor 120 may acquire the de-burn-in layer 1130 in the secure mode. According to an embodiment of the disclosure, when the de-burn-in layer 1130 is present in the TEE storage 740 in the secure mode, the processor 120 may acquire the de-burn-in layer 1130 from the TEE storage 740 in the secure mode. According to an embodiment of the disclosure, when a de-burn-in layer is not present in the TEE storage 740 in the secure mode, the processor 120 may acquire the de-burn-in layer 1130 (e.g., recent de-burn-in layer) that is generated in the normal mode and stored in the storage 720.

In operation 1007, the processor 120 may display the de-burn-in screen to which the de-burn-in layer 1130 is applied on the secure screen. An example of this is illustrated in FIG. 11. According to an embodiment of the disclosure, FIG. 11 may represent an example of an operation of providing the screen updated with the de-burn-in layer 1130 in response to the de-burn-in request from the user while displaying the TUI screen on the display in the electronic device 101 (e.g., TUI module 733). According to an embodiment of the disclosure, with reference to FIG. 11, as exemplified in example <1103>, the processor 120 may display a de-burn-in screen 1140 to which the de-burn-in layer 1130 is applied (e.g., screen 1140 to which de-burn-in layer 1130 is temporarily applied) on the secure screen in the secure mode through at least a portion of the display.

In operation 1009, the processor 120 may request the user approval for the de-burn-in screen 1140 (e.g., screen 1140 to which de-burn-in layer 1130 is temporarily applied). According to an embodiment of the disclosure, the processor 120 may acquire a user input related to whether to apply the de-burn-in layer 1130 to the secure screen 1110 in the secure mode, and may display the de-burn-in screen 1140 to which the de-burn-in layer 1130 is applied through at least a portion of the display based on the user input in the secure mode. An example of this is illustrated in FIG. 11.

For example, as exemplified in FIG. 11, the processor 120 may display the secure screen 1110 before the de-burn-in layer 1130 is applied in the secure mode and may display the de-burn-in screen 1140 to which the de-burn-in layer 1130 is applied (e.g., screen 1140 to which de-burn-in layer 1130 is temporarily applied) on the secure screen 1110, in response to the user input based on the indicator 1120 in the secure mode. According to an embodiment of the disclosure, the processor 120 may provide a selection entity for user approval for the de-burn-in screen 1140 (e.g., determining whether to apply de-burn-in layer 1130) based on an area defined on the de-burn-in screen 1140. For example, the processor 120 may provide a selection entity, such as the first option for application of the de-burn-in layer 1130 (e.g., “OK” button 1150) and the second option for nonapplication of the de-burn-in layer 1130 (e.g., “Not OK” button 1160). According to an embodiment of the disclosure, the selection entity (e.g., “OK” button 1150 and “Not OK” button 1160) may be displayed through at least a portion of the de-burn-in screen 1140 to which the de-burn-in layer 1130 is applied (e.g., screen 1140 to which de-burn-in layer 1130 is temporarily applied).

According to an embodiment of the disclosure, implementation for user approval for the de-burn-in screen 1140 (e.g., determining whether to apply de-burn-in layer 1130) may be provided, for example, using a physical button of the electronic device 101 or defined GUI. An example of this is illustrated in FIG. 12.

As exemplified in example <1201> of FIG. 12, the electronic device 101 may provide a first option for application of the de-burn-in layer 1130 (e.g., volume up button) and a second operation for nonapplication of the de-burn-in layer 1130 (e.g., volume down button) based on a physical button (e.g., volume up/down buttons 1210). For example, the electronic device 101 may request the user approval related to whether to apply the de-burn-in layer 1130 by guiding the user's selection (e.g., click) on the physical button (e.g., volume up/down buttons 1210).

As exemplified in example <1203> of FIG. 12, the electronic device 101 may provide a first option for application of the de-burn-in layer 1130 (e.g., “Button 1” button) and a second option for nonapplication of the de-burn-in layer 1130 (e.g., “Button 2” button) based on GUI 1230 (e.g., software button) provided on the de-burn-in screen 1140 (e.g., screen 1140 to which de-burn-in layer 1130 is temporarily applied). For example, the electronic device 101 may request the user approval related to whether to apply the de-burn-in layer 1130 by guiding the user's selection (e.g., click) on the defined GUI 1230 (e.g., “Button 1” button or “Button 2” button).

In operation 1011, the processor 120 may determine whether the user approves the de-burn-in screen 1140. According to an embodiment of the disclosure, the processor 120 may receive an input related to a selection on the first option (e.g., option for application of de-burn-in layer 1130) or the second option (e.g., option for nonapplication of de-burn-in layer 1130) from the user based on the GUI and/or physical button.

Based on the user's approval acquired for the de-burn-in screen 1140 in operation 1011 (‘Yes’ in operation 1011), the processor 120 may sign the de-burn-in layer 1130 in operation 1013. According to an embodiment of the disclosure, when the first option is selected by the user input, the processor 120 may display (or apply or update) the de-burn-in screen 1140 to which the de-burn-in layer 1130 is applied on the secure screen 1110 through at least a portion of the display.

In operation 1015, the processor 120 may store the signed de-burn-in layer 1130. According to an embodiment of the disclosure, the processor 120 may store the de-burn-in layer 1130 in the TEE storage 740 based on the verification of the de-burn-in layer 1130.

Based on the user's rejection acquired for the de-burn-in screen 1140 in operation 1011 (e.g., ‘No’ in operation 1011), the processor 120 may remove the de-burn-in layer 1130 temporarily applied to the secure screen 1110 and may cancel the de-burn-in screen 1140 in operation 1017. According to an embodiment of the disclosure, when the second option is selected by the user input, the processor 120 may display the secure screen 1110 before the de-burn-in layer 1130 is applied. For example, if the de-burn-in screen is rejected by the user, the processor 120 may cancel application of the de-burn-in layer on the secure screen 1110.

In operation 1019, the processor 120 may display the secure screen 1110 before the de-burn-in screen 1140 is applied.

According to the disclosure, in relation to providing a secure screen based on a de-burn-in layer, whether to apply the de-burn-in layer may be automatically determined and applied by the electronic device 101 (e.g., processor 120, artificial intelligence, and/or instructions) without user intervention. For example, the electronic device 101 may identify a switch event based on the processor 120 and/or artificial intelligence, may select a de-burn-in layer corresponding (or defined) to a state of the electronic device 101 (e.g., state of display or size of displayed screen or screen display area) and/or an executed application among the defined plurality of de-burn-in layers in response to the switch event, and may update the screen based on the selected de-burn-in layer (e.g., apply de-burn-in layer).

According to the disclosure, in relation to providing a secure screen based on a de-burn-in layer, whether to apply the de-burn-in layer may be applied based on the user's selection through interaction with the user. For example, the electronic device 101 may identify a switch event based on the processor 120 and/or artificial intelligence, and may guide the user to select whether to apply the de-burn-in layer in response to the switch event. According to an embodiment of the disclosure, the electronic device 101 may select a de-burn-in layer corresponding (or defined) to a state of the electronic device 101 (e.g., state of display or size of displayed screen or screen display area) and/or an executed application among the defined plurality of de-burn-in layers and may provide the selected de-burn-in layer to the user (e.g., display a guide screen), and in response to the user's confirmation regarding whether to apply the de-burn-in layer, may update the screen based on the selected de-burn-in layer (e.g., apply de-burn-in layer), or may display the screen without updating the de-burn-in layer.

An operating method performed by the electronic device 101 according to an embodiment of the disclosure may include generating a de-burn-in layer for a normal screen in a normal mode. The operating method may include identifying a switch event to a secure mode in the normal mode. The operating method may include switching from the normal mode to the secure mode in response to the switch event. The operating method may include acquiring the de-burn-in layer in the secure mode. The operating method may include displaying the secure screen to which the de-burn-in layer is applied through at least a portion of a display in the secure mode.

According to an embodiment of the disclosure, the electronic device 101 may include at least one storage that includes a first storage portion corresponding to the normal mode and a second storage portion corresponding to the secure mode.

According to an embodiment of the disclosure, the operating method may include storing the generated de-burn-in layer in the first storage portion in the normal mode. The operating method may include storing the de-burn-in layer stored in the first storage portion in the second storage portion in the secure mode. The operating method may include acquiring the de-burn-in layer by loading the de-burn-in layer stored in the second storage portion in the secure mode.

According to an embodiment of the disclosure, the operating method may include verifying the de-burn-in layer in the secure mode. The operating method may include displaying the secure screen to which the de-burn-in layer is applied through at least a portion of the display based on the verification.

According to an embodiment of the disclosure, the operating method may include storing the de-burn-in layer in the second storage portion based on the verification.

According to an embodiment of the disclosure, the operating method may include performing the verification by identifying that forgery is absent in data of the de-burn-in layer between a point in time of storing the de-burn-in layer in the second storage portion and a point in time of loading the de-burn-in layer from the second storage portion.

According to an embodiment of the disclosure, the operating method may include performing the verification by signing the de-burn-in layer with a signing key corresponding to the secure screen.

According to an embodiment of the disclosure, the operating method may include acquiring a user input related to whether to apply the de-burn-in layer to the secure screen in the secure mode. The operating method may include displaying the secure screen to which the de-burn-in layer is applied through at least a portion of the display based on the user input, in the secure mode.

According to an embodiment of the disclosure, the operating method may include displaying another secure screen before the de-burn-in layer is applied in the secure mode. The operating method may include displaying a GUI for the user input on at least a portion of the other secure screen before the de-burn-in layer is applied in the secure mode.

According to an embodiment of the disclosure, the operating method may include displaying the GUI on at least a portion of the other secure screen before the de-burn-in layer is applied, such that the GUI includes a first option for application of the de-burn-in layer and a second option for nonapplication of the de-burn-in layer.

According to an embodiment of the disclosure, the operating method may include displaying the secure screen to which the de-burn-in layer is applied through at least a portion of the display when the first option is selected by the user input. The operating method may include displaying the other secure screen before the de-burn-in layer is applied when the second option is selected by the user input.

According to an embodiment of the disclosure, the operating method may include disallowing the user input to be received through the normal mode in the secure mode.

According to an embodiment of the disclosure, the operating method may include learning whether to apply the de-burn-in layer to the secure screen through machine learning or artificial intelligence. The operating metho may include automatically selecting a single secure screen between the secure screen to which the de-burn-in layer is applied and another secure screen before the de-burn-in layer is applied, based on the learning results, and displaying the selected single secure screen through at least a portion of the display.

According to an embodiment of the disclosure, the operating method may include displaying an indicator indicating the secure mode on at least a portion of the secure screen in the secure mode.

According to an embodiment of the disclosure, the switch event may include a payment request in a financial application.

According to an embodiment of the disclosure, the operating method may include generating and storing a plurality of de-burn-in layers corresponding to a plurality of states of the display and/or a plurality of de-burn-in layers corresponding to a plurality of applications. According to an embodiment of the disclosure, the operating method may include acquiring the de-burn-in layer based on a state of the display and/or an executed application among the plurality of de-burn-in layers.

According to an embodiment of the disclosure, the operating method may include generating another de-burn-in layer for the secure screen in the secure mode. The operating method may include updating the de-burn-in layer based on the other de-burn-in layer in the normal mode.

According to an embodiment of the disclosure, the display module 160 may be configured to provide a first state having a first screen size and a second state having a second screen size larger than the first screen size.

According to an embodiment of the disclosure, the operating method may include generating a first de-burn-in layer corresponding to the first state and a second de-burn-in layer corresponding to the second state as the other de-burn-in layers in the secure mode. The operating method may include updating the de-burn-in layer based on at least one of the first de-burn-in layer and the second de-burn-in layer in the normal mode.

According to an embodiment of the disclosure, the operating method may include generating a first de-burn-in layer corresponding to the first state and a second de-burn-in layer corresponding to the second state as the de-burn-in layers for the normal screen in the normal mode. The operating method may include displaying the secure screen to which the de-burn-in layer is applied through at least a portion of the display, based on corresponding one of the first de-burn-in layer and the second de-burn-in layer in the secure mode.

In a non-transitory computer-readable medium storing instructions that, when executed by the processor 120 of the electronic device 101, cause the processor 120 to perform operations, the instructions, when executed by the processor, may cause the electronic device to perform the operations of generating a de-burn-in layer for a normal screen in a normal mode, identifying a switch event to a secure mode in the normal mode, switching from the normal mode to the secure mode in response to the switch event, acquiring the de-burn-in layer in the secure mode, and displaying a secure screen to which the de-burn-in layer is applied through at least a portion of a display in the secure mode.

It will be understood that the above-described embodiments and their technical features may be potentially combined with each other in all combinations as long as there is no conflict between two embodiments or features. For example, any combination of two or more of the above-described embodiments may be configured and included within the disclosure. One or more features from any embodiment may be integrated in any other embodiment of the disclosure, and may provide corresponding advantage or advantages.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., module or program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display configured to be capable of displaying a normal screen corresponding to a normal mode and a secure screen corresponding to a secure mode;
memory, comprising one or more storage media, storing instructions; and
at least one processor, configured to be capable of operating in the normal mode and the secure mode, communicatively coupled to the display and the memory,
wherein the instructions, when individually and/or collectively executed by the at least one processor, cause the electronic device to:
generate a de-burn-in layer for the normal screen in the normal mode,
identify a switch event to the secure mode in the normal mode,
switch from the normal mode to the secure mode in response to the switch event,
acquire the de-burn-in layer in the secure mode, and
display the secure screen to which the de-burn-in layer is applied through at least a portion of the display in the secure mode.

2. The electronic device of claim 1,
wherein the electronic device includes at least one storage that includes a first storage portion corresponding to the normal mode and a second storage portion corresponding to the secure mode, and
wherein the instructions, when individually and/or collectively executed by the at least one processor, further cause the electronic device to:
store the generated de-burn-in layer in the first storage portion in the normal mode,
store the de-burn-in layer stored in the first storage portion in the second storage portion in the secure mode, and
acquire the de-burn-in layer by loading the de-burn-in layer stored in the second storage portion in the secure mode.

3. The electronic device of claim 2, wherein the instructions, when individually and/or collectively executed by the at least one processor, further cause the electronic device to:
verify the de-burn-in layer in the secure mode, and
display the secure screen to which the de-burn-in layer is applied through at least a portion of the display based on the verification.

4. The electronic device of claim 3, wherein the instructions, when individually and/or collectively executed by the at least one processor, further cause the electronic device to
store the de-burn-in layer in the second storage portion based on the verification, and
perform the verification by identifying that forgery is absent in data of the de-burn-in layer between a point in time of storing the de-burn-in layer in the second storage portion and a point in time of loading the de-burn-in layer from the second storage portion.

5. The electronic device of claim 3, wherein the instructions, when individually and/or collectively executed by the at least one processor, further cause the electronic device to perform the verification by signing the de-burn-in layer with a signing key corresponding to the secure screen.

6. The electronic device of claim 1, wherein the instructions, when individually and/or collectively executed by the at least one processor, further cause the electronic device to:
acquire a user input related to whether to apply the de-burn-in layer to the secure screen in the secure mode, and
display the secure screen to which the de-burn-in layer is applied through at least a portion of the display based on the user input, in the secure mode.

7. The electronic device of claim 6, wherein the instructions, when individually and/or collectively executed by the at least one processor, further cause the electronic device to:
display another secure screen before the de-burn-in layer is applied in the secure mode, and
display a graphical user interface (GUI) for the user input on at least a portion of the other secure screen before the de-burn-in layer is applied in the secure mode.

8. The electronic device of claim 7, wherein the instructions, when individually and/or collectively executed by the at least one processor, further cause the electronic device to
display the GUI on at least a portion of the other secure screen before the de-burn-in layer is applied, such that the GUI includes a first option for application of the de-burn-in layer and a second option for nonapplication of the de-burn-in layer
display the secure screen to which the de-burn-in layer is applied through at least a portion of the display when the first option is selected by the user input, and
display the other secure screen before the de-burn-in layer is applied when the second option is selected by the user input.

9. The electronic device of claim 6, wherein the instructions, when individually and/or collectively executed by the at least one processor, further cause the electronic device to disallow the user input to be received through the normal mode in the secure mode.

10. The electronic device of claim 1, wherein the instructions, when individually and/or collectively executed by the at least one processor, further cause the electronic device to:
learn whether to apply the de-burn-in layer to the secure screen through machine learning or artificial intelligence, and
automatically select a single secure screen between the secure screen to which the de-burn-in layer is applied and another secure screen before the de-burn-in layer is applied, based on the learning results, and display the selected single secure screen through at least a portion of the display.

11. The electronic device of claim 1, wherein the instructions, when individually and/or collectively executed by the at least one processor, further cause the electronic device to display an indicator indicating the secure mode on at least a portion of the secure screen in the secure mode.

12. The electronic device of claim 1, wherein the instructions, when individually or collectively executed by the at least one processor, further cause the electronic device to:
generate and store a plurality of de-burn-in layers corresponding to a plurality of states of the display and/or a plurality of de-burn-in layers corresponding to a plurality of applications, and
acquire the de-burn-in layer based on a state of the display and/or an executed application among the plurality of de-burn-in layers.

13. The electronic device of claim 1, wherein the instructions, when individually and/or collectively executed by the at least one processor, further cause the electronic device to:
generate another de-burn-in layer for the secure screen in the secure mode, and
update the de-burn-in layer based on the other de-burn-in layer in the normal mode.

14. The electronic device of claim 13,
wherein the display is configured to provide a first state having a first screen size and a second state having a second screen size larger than the first screen size, and
wherein the instructions, when individually and/or collectively executed by the at least one processor, further cause the electronic device to:
generate a first de-burn-in layer corresponding to the first state and a second de-burn-in layer corresponding to the second state as the other de-burn-in layers in the secure mode, and
update the de-burn-in layer based on at least one of the first de-burn-in layer and the second de-burn-in layer in the normal mode.

15. The electronic device of claim 1,
wherein the display is configured to provide a first state having a first screen size and a second state having a second screen size larger than the first screen size, and
wherein the instructions, when individually and/or collectively executed by the at least one processor, further cause the electronic device to:
generate a first de-burn-in layer corresponding to the first state and a second de-burn-in layer corresponding to the second state as the de-burn-in layers for the normal screen in the normal mode, and
display the secure screen to which the de-burn-in layer is applied through at least a portion of the display, based on corresponding one of the first de-burn-in layer and the second de-burn-in layer in the secure mode.

16. A method of operating an electronic device, the method comprising:
generating a de-burn-in layer for a normal screen in a normal mode;
identifying a switch event to a secure mode in the normal mode;
switching from the normal mode to the secure mode in response to the switch event;
acquiring the de-burn-in layer in the secure mode; and
displaying a secure screen to which the de-burn-in layer is applied through at least a portion of a display in the secure mode.

17. The method of claim 16,
wherein the electronic device includes at least one storage that includes a first storage portion corresponding to the normal mode and a second storage portion corresponding to the secure mode, and
wherein the acquiring of the de-burn-in layer comprises:
storing the generated de-burn-in layer in the first storage portion in the normal mode;
storing the de-burn-in layer stored in the first storage portion in the second storage portion in the secure mode; and
acquiring the de-burn-in layer by loading the de-burn-in layer stored in the second storage portion in the secure mode.

18. The method of claim 17, further comprising:
verifying the de-burn-in layer in the secure mode; and
displaying the secure screen to which the de-burn-in layer is applied through at least a portion of the display based on the verification.

19. One or more non-transitory computer-readable storage media storing one or more computer programs including computer-executable instructions that, when executed individually or collectively by at least one processor of an electronic device, cause the electronic device to perform operations, the operations comprising:
generating a de-burn-in layer for a normal screen in a normal mode;
identifying a switch event to a secure mode in the normal mode;
switching from the normal mode to the secure mode in response to the switch event;
acquiring the de-burn-in layer in the secure mode; and
displaying a secure screen to which the de-burn-in layer is applied through at least a portion of a display in the secure mode.

20. The one or more non-transitory computer-readable storage media of claim 19,
wherein the electronic device includes at least one storage that includes a first storage portion corresponding to the normal mode and a second storage portion corresponding to the secure mode, and
wherein the operations further comprising:
storing the generated de-burn-in layer in the first storage portion in the normal mode;
storing the de-burn-in layer stored in the first storage portion in the second storage portion in the secure mode; and
acquiring the de-burn-in layer by loading the de-burn-in layer stored in the second storage portion in the secure mode.
